(19) United States
(12) Patent Application Publication
(10) Pub. No.: US 2020/0313161 A1
(43) Pub. Date: Oct. 1, 2020

(54) ELECTRODE SHEET FOR ALL-SOLID STATE SECONDARY BATTERY, ALL-SOLID STATE SECONDARY BATTERY, AND METHOD OF MANUFACTURING ELECTRODE SHEET FOR ALL-SOLID STATE SECONDARY BATTERY AND ALL-SOLID STATE SECONDARY BATTERY

(71) Applicant: FUJIFILM Corporation, Tokyo (JP)

(72) Inventors: Hiroshi ISOJIMA, Kanagawa (JP); Shin OZAWA, Kanagawa (JP)

(73) Assignee: FUJIFILM Corporation, Tokyo (JP)

(21) Appl. No.: 16/902,275

(22) Filed: Jun. 16, 2020

Related U.S. Application Data
(63) Continuation of application No. PCT/JP2019/003297, filed on Jan. 31, 2019.

(30) Foreign Application Priority Data
Feb. 5, 2018 (JP) 2018-018677
Jun. 8, 2018 (JP) 2018-109966

(51) Int. Cl. H01M 4/131; H01M 10/0562; H01M 10/0585; H01M 4/66; H01M 4/133; H01M 4/1391; H01M 4/1393; H01M 4/62; H01M 10/0525

(52) U.S. Cl. CPC H01M 4/131; H01M 10/0562; H01M 10/0585; H01M 4/663; H01M 4/505; H01M 4/1391; H01M 4/1393; H01M 4/62; H01M 10/0525; H01M 4/133

(57) ABSTRACT

Provided are an electrode sheet for an all-solid state secondary battery, including, in the following order: a conductor layer containing conductive particles (C); and an electrode active material layer on at least one surface of an electrode collector,

in which the electrode active material layer containing an active material (A) having a median diameter Rₐₘ and an inorganic solid electrolyte (B) having a median diameter Rₛₑ is provided on a surface of the conductor layer having a maximum height roughness Rz of 3.0 to 10 μm, which is defined in JIS B 0601:2013, and

Rₐₘ, Rₛₑ, and Rz satisfy the following Expressions (1) and (2), an all-solid state secondary battery provided with the electrode sheet for an all-solid state secondary battery, and a method thereof.

0.15<Rz/Rₐₘ<90 Expression (1):

0.15<Rz/Rₛₑ<90 Expression (2):

### CROSS-REFERENCE TO RELATED APPLICATIONS

This application is a Continuation of PCT International Application No. PCT/JP2019/003297 filed on Jan. 31, 2019, which claims priorities under 35 U.S.C. § 119 (a) to Japanese Patent Application No. 2018-018677 filed in Japan on Feb. 5, 2018 and Japanese Patent Application No. 2018-109966 filed in Japan on Jun. 8, 2018. Each of the above applications is hereby expressly incorporated by reference, in its entirety, into the present application.

### BACKGROUND OF THE INVENTION

### 1. Field of the Invention

The present invention relates to an electrode sheet for an all-solid state secondary battery, an all-solid state secondary battery, and a method of manufacturing an electrode sheet for an all-solid state secondary battery and an all-solid state secondary battery.

### 2. Description of the Related Art

A lithium ion secondary battery is a storage battery which has a negative electrode, a positive electrode, and an electrolyte sandwiched between the negative electrode and the positive electrode and enables charging and discharging by reciprocal migration of lithium ions between both electrodes. In the related art, an organic electrolytic solution has been used in a lithium ion secondary battery as an electrolyte. However, the organic electrolytic solution is likely to leak, and a short circuit may occur in the battery due to overcharging or overdischarging so as to cause ignition. Therefore, further improvement in safety and reliability is required.

Under such circumstances, an all-solid state secondary battery formed of an inorganic solid electrolyte instead of an organic electrolytic solution has attracted attention. The negative electrode, the electrolyte, and the positive electrode of the all-solid state secondary battery are all made of solid, and thus safety or reliability that is a problem of a battery formed of an organic electrolytic solution can be greatly improved. In addition, it is possible to achieve a longer life. Furthermore, the all-solid state secondary battery can have a laminated structure in which electrodes and electrolytes are directly disposed side by side and arranged in line. Therefore, it is possible to achieve higher energy density compared to a secondary battery using organic electrolyte solutions, and thus the all-solid lithium ion secondary battery is expected to be applied to electric vehicles, large-sized storage batteries, and the like.

In order to put such an all-solid state secondary battery to practical use, studies on components disposed on a positive electrode side or a negative electrode side have been actively conducted.

For example, in JP6239936B, it is described that in a case where an electrode collector and an electrode active material layer weakly closely attached to each other, contamination may be generated due to peeling of the electrode active material layer during sheet cutting in a laminate-type lithium ion secondary battery. In order to deal with this problem, the electrode current collector described in JP6239936B has a carbon coating layer having asperity on a side in contact with an electrode active material layer.

It is described in JP2016-213124A that in a case where an electrode laminate having a conductor layer is employed in a battery after being pressed, peeling between the conductor layer and an electrode active material layer is likely to occur. In order to deal with this problem, the electrode laminate described in JP2016-213124A includes an electrode collector layer, a conductor layer provided on a surface of the electrode collector layer, and an electrode active material layer provided on the surface of the conductor layer, in which surface roughness of the conductor layer on the electrode active material layer side is set in a specific range.

### SUMMARY OF THE INVENTION

An electrode sheet for an all-solid state secondary battery having an electrode active material layer on a conductor layer interposing an electrode collector therebetween is generally distributed in a rolled state. Therefore, it is required that the electrode sheet for an all-solid state secondary battery have characteristics that peeling between the electrode active material layer and the conductor layer is not likely to occur even though the electrode sheet for an all-solid state secondary battery is bent (wound in a roll state) at a small bending radius.

Accordingly, an object of the present invention is to provide an electrode sheet for an all-solid state secondary battery, in which peeling between an electrode active material layer and a conductor layer is not likely to occur even though the electrode sheet for an all-solid state secondary battery is bent at a small bending radius to be a roll state and the roll state is released, and the electrode sheet for an all-solid state secondary battery is used as a component formed in a laminated state, so that an all-solid state secondary battery having an excellent discharge capacity can be realized.

In addition, another object of the present invention is to provide an all-solid state secondary battery having the above described electrode sheet for an all-solid state secondary battery and having an excellent discharge capacity, and a method of manufacturing the same.

The present inventors have conducted intensive studies in view of the above problems. As a result, the present inventors found that in an electrode sheet for an all-solid state secondary battery including an electrode active material layer that is disposed on an electrode collector interposing a conductor layer containing conductive particles between the conductor layer and the electrode active material layer and that contains a specific active material and a specific inorganic solid electrolyte, asperity having a maximum height roughness within a specific range is provided on a surface of the electrode active material layer side on the conductor layer, and a relationship of a median diameter of the active material and the maximum height roughness and a relationship of a median diameter of the inorganic solid electrolyte and the maximum height roughness are set to specific relationships, respectively, so that the problem can be solved. The present invention was completed by repeating additional studies on the basis of the above described finding.

That is, the above described objects have been achieved by the following means.

<1> An electrode sheet for an all-solid state secondary battery, comprising, in the following order: a conductor layer containing conductive particles (C); and an electrode active material layer on at least one surface of an electrode collector,

in which the electrode active material layer containing an active material (A) having a median diameter Rₐₘ and an inorganic solid electrolyte (B) having a median diameter Rₛₑ is provided on a surface of the conductor layer having a maximum height roughness Rz of 3.0 to 10 μm, which is defined in JIS B 0601:2013, and

Rₐₘ, Rₛₑ, and Rz satisfy the following Expressions (1) and (2).

0.15<Rz/Rₐₘ<90 Expression (1):

0.15<Rz/Rₛₑ<90 Expression (2):

<2> The electrode sheet for an all-solid state secondary battery according to <1>, in which Rₐₘ and Rₛₑ satisfy the following Expression (3).

Rₛₑ<Rₐₘ Expression (3):

<3> The electrode sheet for an all-solid state secondary battery according to <1> or <2>, in which the conductive particles (C) include carbon particles (C1).

<4> The electrode sheet for an all-solid state secondary battery according to any one of <1> to <3>, in which Rₛₑ is 0.2 μm or more and 7 μm or less.

<5> The electrode sheet for an all-solid state secondary battery according to any one of <1> to <4>, in which Rₐₘ is 0.5 μm or more and 10 μm or less.

<6> The electrode sheet for an all-solid state secondary battery according to any one of <1> to <5>, in which the conductor layer contains a binder (D).

<7> An all-solid state secondary battery comprising the electrode sheet for an all-solid state secondary battery according to any one of <1> to <6>.

<8> A method of manufacturing an electrode sheet for an all-solid state secondary battery, which includes, in the following order: a conductor layer containing conductive particles (C); and an electrode active material layer on at least one surface of an electrode collector, and

in which the electrode active material layer containing an active material (A) having a median diameter Rₐₘ and an inorganic solid electrolyte (B) having a median diameter Rₛₑ is provided on a surface of the conductor layer having a maximum height roughness Rz of 3.0 to 10 μm defined in JIS B 0601:2013, the method comprising:

a step of adjusting Rz with the conductive particles (C),

in which Rₐₘ, Rₛₑ, and Rz satisfy the following Expressions (1) and (2).

0.15<Rz/Rₐₘ<90 Expression (1):

0.15<Rz/Rₛₑ<90 Expression (2):

<9> The method of manufacturing an electrode sheet for an all-solid state secondary battery according to <8>, in which Rₐₘ and Rₛₑ satisfy the following Expression (3).

Rₛₑ<Rₐₘ Expression (3):

<10> The method of manufacturing an electrode sheet for an all-solid state secondary battery according to <8> or <9>, in which the conductive particles (C) include carbon particles (C1).

<11> The method of manufacturing an electrode sheet for an all-solid state secondary battery according to any one of <8> to <10>, in which Rₛₑ is 0.2 μm or more and 7 μm or less.

<12> The method of manufacturing an electrode sheet for an all-solid state secondary battery according to any one of <8> to <11>, in which Rₐm is 0.5 μm or more and 10 μm or less.

<13> The method of manufacturing an electrode sheet for an all-solid state secondary battery according to any one of <8> to <12>, in which the conductor layer contains a binder (D).

<14> A method of manufacturing an all-solid state secondary battery comprising a step of incorporating the electrode sheet for an all-solid state secondary battery, which is obtained by the method of manufacturing an electrode sheet for an all-solid state secondary battery according to any one of <8> to <13>.

The electrode sheet for an all-solid state secondary battery of the present invention, in which peeling between an electrode active material layer and a conductor layer is not likely to occur even though the electrode sheet for an all-solid state secondary battery is bent at a small bending radius to be a roll state and the roll state is released, is used as a component formed in a laminated state, so that an all-solid state secondary battery having an excellent discharge capacity can be realized.

Furthermore, the all-solid state secondary battery of the present invention provided with the above described electrode sheet for an all-solid state secondary battery has an excellent discharge capacity.

According to the method of manufacturing the electrode sheet for an all-solid state secondary battery and the all-solid state secondary battery the present invention, the above described electrode sheet for an all-solid state secondary battery and the all-solid state secondary battery according to the embodiment of the present invention can be obtained.

### BRIEF DESCRIPTION OF THE DRAWINGS

FIG. 1 is a longitudinal cross-sectional view schematically illustrating an electrode sheet for an all-solid state secondary battery according to a preferred embodiment of the present invention.

FIG. 2 is a longitudinal cross-sectional view schematically illustrating an all-solid state secondary battery (coin battery) according to a preferred embodiment of the present invention.

FIG. 3 is a chart illustrating a measurement result of a maximum height roughness Rz of a conductor layer constituting an electrode sheet for an all-solid state secondary battery produced in Comparative Example (condition 1).

FIG. 4 is a chart illustrating a measurement result of a maximum height roughness Rz of a conductor layer constituting an electrode sheet for an all-solid state secondary battery produced in Example (condition 2).

FIG. 5 is a chart illustrating a measurement result of a maximum height roughness Rz of a conductor layer constituting an electrode sheet for an all-solid state secondary battery produced in Example (condition 8).

### DESCRIPTION OF THE PREFERRED EMBODIMENTS

In the description of the present invention, numerical ranges expressed using “to” include numerical values before and after the “to” as the lower limit value and the upper limit value.

<Electrode Sheet for all-Solid State Secondary Battery>

An electrode sheet for an all-solid state secondary battery (hereinafter, also referred to as an “electrode sheet”) has a conductor layer on at least one surface of an electrode collector, and an electrode active material layer containing an active material (A) having a median diameter Rₐₘ and an inorganic solid electrolyte (B) having a median diameter Rₛₑ that are contained on a surface opposite to the electrode collector of the conductor layer (brought in contact with the conductor layer on the conductor layer) having a maximum height roughness Rz of 3.0 μm to 10 μm defined in JIS B 0601:2013. The above described Rₐₘ, Rₛₑ, and Rz satisfy the following Expressions (1) and (2).

0.15<Rz/Rₐₘ<90 Expression (1):

0.15<Rz/Rₛₑ<90 Expression (2):

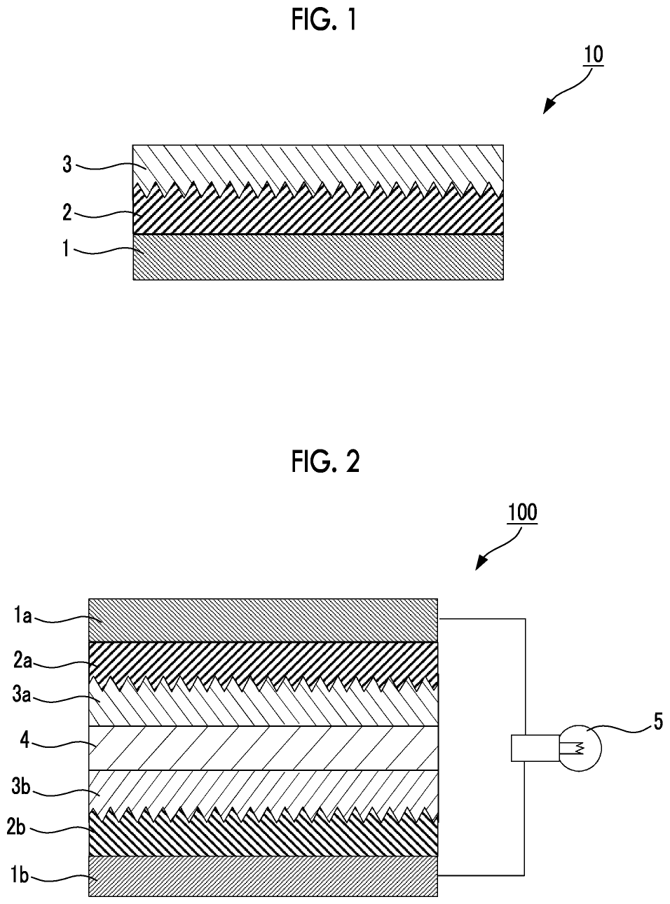

In an electrode sheet for an all-solid state secondary battery 10 according to a preferred embodiment of the present invention shown in FIG. 1, a conductor layer 2 is disposed on an electrode current collector (electrode collector) 1, and an electrode active material layer 3 is disposed on the conductor layer 2.

The electrode sheet according to the embodiment of the present invention has the above configuration, whereby peeling between the electrode active material layer and the conductor layer is not likely to occur. Furthermore, it is possible to realize an all-solid state secondary battery having an excellent discharge capacity by using the electrode sheet according to the embodiment of the present invention as a component.

The reason for this is not clear, but the conductor layer has asperity on an adhesive interface side with the electrode active material layer, and the above described Rₐₘ, Rₛₑ, and Rz satisfy the relationship of Expressions (1) and (2), whereby at least parts of the active material (A) and the inorganic solid electrolyte (B) enter a recessed portion. As a result, it is considered that this is because physical interaction (anchor effect) between the conductor layer and the electrode active material layer is strengthened.

In the electrode sheet according to the embodiment of the present invention, it is preferable that Rₐₘ and Rₛₑ satisfy the following Expression (3).

R_{sc}<Rₐₘ Expression (3):

It is considered that in a case where Rz and Expressions (1) to (3) are in the following preferable ranges, the synergistic anchor effect is exhibited.

Rz is preferably 3.0 am or more and 9 μm or less, more preferably 3.0 μm or more and 8 μm or less, and particularly preferably 3.0 μm or more and 6 μm or less.

The lower limit of the values obtained from Expression (1) is preferably more than 0.3, more preferably more than 0.4, and even more preferably more than 1. The upper limit of the values obtained from Expression (1) is preferably less than 10, and more preferably less than 5.

Expression (1) is preferably the following Expression (1a), and more preferably the following Expression (1b).

0.3<Rz/Rₐₘ<10 Expression (1a):

1<Rz/Rₐₘ<5 Expression (1b):

The lower limit of the values obtained from Expression (2) is preferably more than 0.3, and more preferably more than 0.6. The upper limit of the values obtained from Expression (2) is preferably less than 18, and more preferably less than 12.

Expression (2) is preferably the following Expression (2a), and more preferably the following Expression (2b).

0.3<Rz/Rₛₑ<18 Expression (2a):

0.3<Rz/Rₛₑ<12 Expression (2b):

The lower limit of the values obtained from Expression (3) is preferably more than 1. The upper limit of the values obtained from Expression (3) is preferably less than 100, more preferably less than 50, and more preferably less than 20.

Expression (3): Rₛₑ<Rₐₘ is preferably the following Expression (3a), and more preferably the following Expression (3b).

1<Rₐₘ/Rₛₑ<100 Expression (3a):

1<Rₐₘ/Rₛₑ<50 Expression (3b):

In the electrode sheet for an all-solid state secondary battery according to the embodiment of the present invention, or in the all-solid state secondary battery having the electrode sheet for an all-solid state secondary battery according to the embodiment of the present invention, the above described Rₐₘ, Rₛₑ, and Rz are values obtained by a measurement method described in the section of Example described later. In addition, regarding the electrode sheet for an all-solid state secondary battery or the all-solid state secondary battery, a measurement method of Rz is (2) of the measurement methods (1) and (2) described in Example.

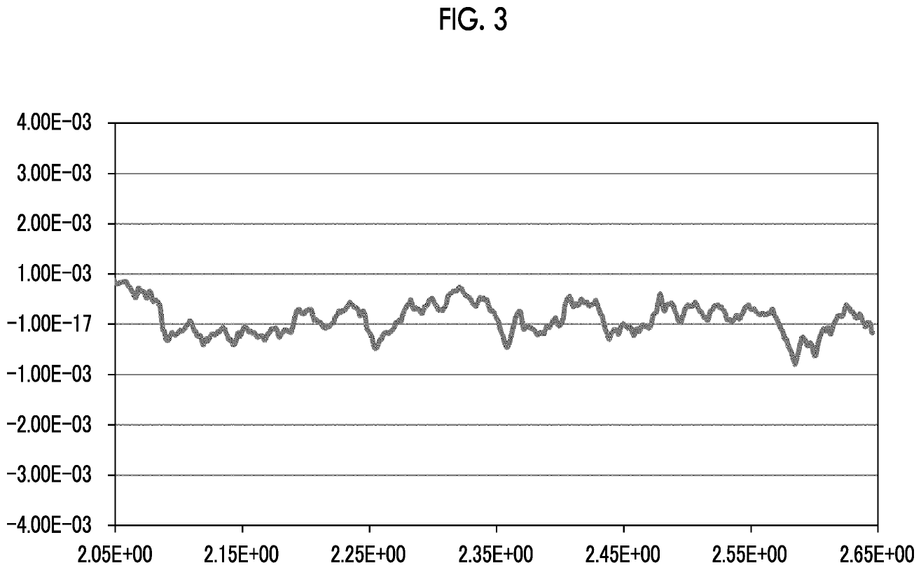

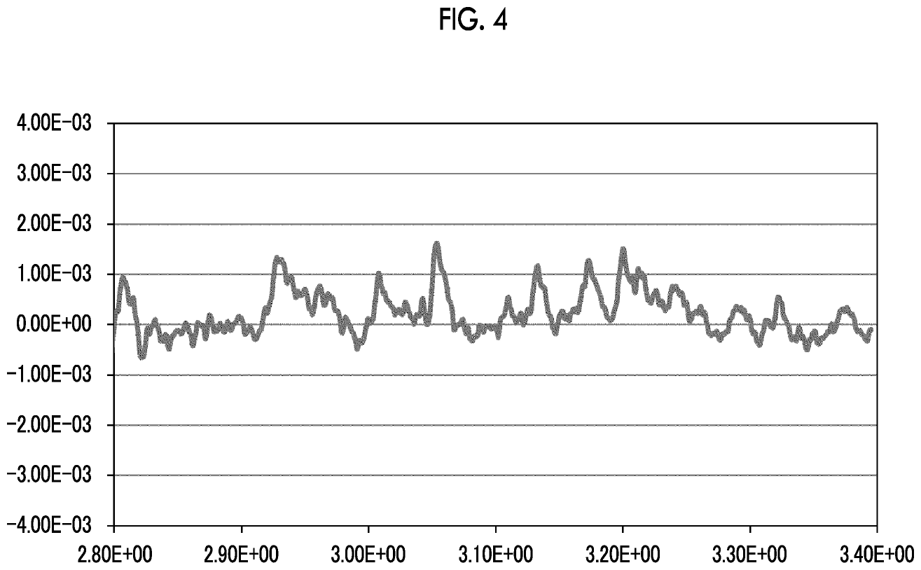

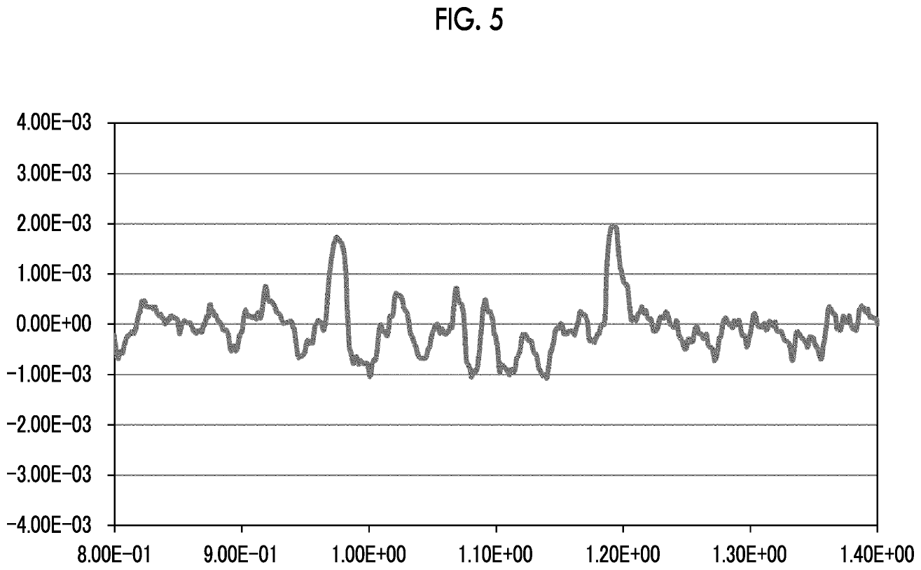

FIGS. 3 to 5 are charts illustrating measurement results of Rz in a part of the electrode sheets for an all-solid state secondary battery produced in Examples and Comparative Examples. In FIGS. 3 to 5, a lateral axis indicates a depth (height) of asperity (unit: mm), and a horizontal axis indicates a position (unit: mm) from one end of a sheet in the horizontal axis (width) direction.

Rₛₑ is not particularly limited as long as Rₛₑ satisfies the above Expression (2), but the lower limit is preferably 0.1 μm or more, more preferably 0.2 μm or more, and particularly preferably 0.3 μm or more. The upper limit is preferably 15 μm or less, more preferably 7 μm or less, and particularly preferably 3 μm or less.

This is because, in a case where Rₛₑ is in the above range, the inorganic solid electrolyte can easily enter the asperity of the conductor layer, can maintain crystallinity and high ion conductivity, accordingly binding properties between the conductor layer and the electrode active material layer are further improved, and the discharge capacity of the all-solid state secondary battery is also improved.

Rₐₘ is not particularly limited as long as Rₐₘ satisfies the above Expression (1), but the lower limit is preferably 0.15 μm or more, more preferably 0.5 μm or more, and particularly preferably 1.0 μm or more. The upper limit is preferably 30 μm or less, more preferably 10 μm or less, and particularly preferably 7 μm or less.

This is because, in a case where Rₐₘ is within the above range, the inorganic solid electrolyte having a smaller particle diameter than the active material can be more adjacent to a periphery of the active material, and thus a conduction path is increased and the discharge capacity is improved.

That is, by appropriately controlling Rₛₑ and Rₐₘ, ion conductivity of the inorganic solid electrolyte and a contact area between the inorganic solid electrolyte and the active material can be balanced, the conduction path can be increased, and the discharge capacity of the all-solid state secondary battery can be improved. Rₛₑ and Rₐₘ can be adjusted by a conventional method.

<Electrode Collector (Metal Foil)>

The positive electrode collector and the negative electrode collector are preferably electronic conductors.

In the present invention, one or both of the positive electrode collector and the negative electrode collector may be simply referred to as an electrode collector.

As materials for forming positive electrode collectors, aluminum, an aluminum alloy, stainless steel, nickel, titanium, or the like, and furthermore, a material obtained by treating the surface of aluminum or stainless steel with carbon, nickel, titanium, or silver (a material forming a thin film) is preferred, and, among these, aluminum and an aluminum alloy are more preferred.

As materials for forming negative electrode collectors, aluminum, copper, a copper alloy, stainless steel, nickel, titanium, or the like, and furthermore, a material obtained by treating the surface of aluminum, copper, a copper alloy, or stainless steel with carbon, nickel, titanium, or silver is preferred, and aluminum, copper, a copper alloy, or stainless steel is more preferred.

Regarding the shape of the electrode collector, generally, electrode collectors having a film sheet-like shape are used, but it is also possible to use net-shaped collectors, punched collectors, compacts of lath bodies, porous bodies, foaming bodies, or fiber groups, and the like.

The thickness of the electrode collector is not particularly limited, but is preferably 1 to 500 μm. In addition, the surface of the electrode collector is preferably provided with asperity by means of a surface treatment.

<Electrode Active Material Layer>

An electrode active material layer contains an active material (A) and an inorganic solid electrolyte (B) described later. The electrode active material layer may contain other components as long as the effects of the present invention are not impaired.

<Conductor Layer>

A conductor layer contains conductive particles (C). The conductor layer may contain other components as long as the effects of the present invention are not impaired.

An electrode sheet for an all-solid state secondary battery of the present invention can be suitably used for an all-solid state secondary battery. This electrode sheet for an all-solid state secondary battery may have other layers as long as the electrode sheet for an all-solid state secondary battery has an electrode collector, a conductor layer, and an electrode active material layer. Examples of the other layers include a protective layer and a solid electrolyte layer.

The electrode sheet for an all-solid state secondary battery according to the embodiment of the present invention is a sheet for forming an electrode of the all-solid state secondary battery according to the embodiment of the present invention, and has a conductor layer and an electrode active material layer on a metal foil as an electrode collector. This electrode sheet is generally a sheet having an electrode collector, a conductor layer, and an active material layer, and examples thereof include an aspect having an electrode collector, a conductor layer, an active material layer, and a solid electrolyte layer in this order, and an aspect having an electrode collector, a conductor layer, an active material layer, a solid electrolyte layer, and an active material layer in this order.

A layer thickness of each layer constituting the electrode sheet is the same as a layer thickness of each layer described in the following description of the all-solid state secondary battery according to the embodiment of the present invention.

Each layer constituting the electrode sheet according to the embodiment of the present invention may contain a dispersant (solvent) within a range in which battery performance is not affected. Specifically, the dispersant may be contained at 1 ppm or more and 10000 ppm or less of the total mass of the above described respective layers.

[All-Solid State Secondary Battery]

An all-solid state secondary battery according to the embodiment of the present invention has a positive electrode, a negative electrode facing the positive electrode, and a solid electrolyte layer between the positive electrode and the negative electrode. The positive electrode has at least a positive electrode collector and a positive electrode active material layer. The negative electrode has at least a negative electrode collector and a negative electrode active material layer. At least one electrode of the positive electrode and the negative electrode is formed using the electrode sheet according to the embodiment of the present invention, and has a conductor layer between the electrode collector and the active material layer.

Hereinafter, a preferred embodiment of the present invention will be described with reference to FIG. 2, but the present invention is not limited thereto.

FIG. 2 is a cross-sectional view schematically illustrating an all-solid state secondary battery (a lithium ion secondary battery) according to a preferred embodiment of the present invention. The all-solid state secondary battery 100 according to the embodiment of the present invention includes, in the following order, a negative electrode collector 1a, a conductor layer 2a, a negative electrode active material layer 3a, a solid electrolyte layer 4, a positive electrode active material layer 3b, a conductor layer 2b, and a positive electrode collector 1b as viewed from the negative electrode side. The respective layers are in contact with one another and have a laminated structure. In a case where the above described structure is employed, during charging, electrons (e⁻) are supplied to the negative electrode side, and lithium ions (Li⁺) are accumulated on the negative electrode side. On the other hand, during discharging, the lithium ions (Li⁺) accumulated on the negative electrode side return to the positive electrode, and electrons are supplied to an operation portion 5. In an example illustrated in the drawing, an electric bulb is employed as the operation portion 5 and is lit by discharging.

Each component contained in the positive electrode active material layer 3b, the solid electrolyte layer 4, the negative electrode active material layer 3a, and the conductor layers 2a and 2b may be the same or different from each other unless otherwise specified.

In the present specification, in some cases, an electrode active material layer (a positive electrode active material layer (hereinafter, also referred to as a positive electrode layer) and a negative electrode active material layer (hereinafter, also referred to as a negative electrode layer)) is referred to as an active material layer.

In a case where an all-solid state secondary battery having the layer constitution shown in FIG. 2 is put into a 2032-type coin case, the all-solid state secondary battery having the layer constitution shown in FIG. 2 will be referred to as a laminate for an all-solid state secondary battery, and a battery produced by putting this laminate for an all-solid state secondary battery into a 2032-type coin case will be referred to as an all-solid state secondary battery, whereby the laminate for an all-solid state secondary battery and the all-solid state secondary battery will be differentiated in some cases.

Thicknesses of the positive electrode active material layer 3b, the solid electrolyte layer 4, and the negative electrode active material layer 3a are not particularly limited. In consideration of dimensions of a general battery, the thickness of each layer is preferably 10 to 1,000 μm, more preferably 20 μm or more and less than 500 μm. In the all-solid state secondary battery according to the embodiment of the present invention, it is even more preferable that at least one of the positive electrode active material layer 3b, the solid electrolyte layer 4, and the negative electrode active material layer 3a has a thickness of 50 μm or more and less than 500 μm. In addition, the thickness of the conductor layer is not particularly limited, but the lower limit is preferably 0.1 μm or more, more preferably 0.4 μm or more, and even more preferably 0.7 μm or more. The upper limit is preferably less than 10 μm, more preferably less than 7 μm, more preferably less than 5 μm, and even more preferably less than 3 μm. This is because the discharge capacity of the all-solid state secondary battery can be further improved.

Here, the term “thickness of conductor layer” refers to a value obtained by a measurement method in Example described later. In addition, in a case where an electrode active material layer is formed on a conductor layer, the value is obtained by subtracting a thickness of the conductor layer from a total thickness of the electrode active material layer and the conductor layer.

In a case where an all-solid state secondary battery according to the embodiment of the present invention has an electrode formed without using an electrode sheet according to the embodiment of the present invention, a thickness of the electrode active material layer is as described above.

In the present invention, a functional layer, a member, or the like may appropriately interposed or provided between respective layers of a negative electrode active material layer, a solid electrolyte layer and/or a positive electrode active material layer, and/or outside a negative electrode collector and/or a positive electrode collector. In addition, the respective layers may be composed of a single layer or multiple layers.

[Housing]

A basic structure of an all-solid state secondary battery can be produced by disposing the above respective layers. Depending on the application, the all-solid state secondary battery may be used as it is, but, in order to have a dry battery cell form, the all-solid state secondary battery is further sealed in an appropriate housing. The housing may be made of metal or resin (plastic). In a case where a metal housing is used, examples thereof include an aluminum alloy housing and a stainless steel housing. It is preferable that the metal housing is separately used as the housing for the positive electrode and the housing for the negative electrode, and the housing for the positive electrode and the housing for the negative electrode are electrically connected to the positive electrode collector and the negative electrode collector, respectively. It is preferable that the housing for the positive electrode and the housing for the negative electrode are bonded together through a gasket for short-circuit prevention and are thus integrated.

Hereinafter, components contained or may be contained in an electrode active material layer or a conductor layer constituting an electrode sheet according to the embodiment of the present invention will be described.

(Active Material (A))

The electrode active material layer in the present invention contains an active material (A). The active material (A) is a particle capable of inserting and releasing ions (preferably lithium ions) of metal elements belonging to Group I or Group II of the periodic table and having a median diameter of Rₐₘ. Hereinafter, the term “active material (A)” may be simply referred to as an “active material” without a reference numeral.

Examples of the active materials include a positive electrode active material and a negative electrode active material, and a metal oxide (preferably a transition metal oxide) as the positive electrode active material, or a metal oxide as the negative electrode active material or metals capable of forming an alloy with lithium, such as Sn, Si, Al and In is preferred.

In the description of the present invention, a solid electrolyte composition containing an active material (a positive electrode active material or a negative electrode active material) may be referred to as an electrode composition (a positive electrode composition or a negative electrode composition).

—Positive Electrode Active Material—

The positive electrode active material capable of reversibly inserting and releasing lithium ions is preferred. The materials thereof are not particularly limited as long as the materials have the above described characteristics and may be transition metal oxides, organic substances, elements capable of being complexed with Li such as sulfur, complexes of sulfur and metal, or the like.

Among these, as the positive electrode active material, transition metal oxides are preferably used, and transition metal oxides having a transition metal element M^{a} (one or more elements selected from Co, Ni, Fe, Mn, Cu, and V) are more preferred. In addition, an element M^{b} (an element of Group I (Ia) of the metal periodic table other than lithium, an element of Group II (IIa), or an element such as Al, Ga, In, Ge, Sn, Pb, Sb, Bi, Si, P, or B) may be mixed into this transition metal oxide. The amount of the element mixed is preferably 0 to 30 mol % of the amount (100 mol %) of the transition metal element M^{a}. The positive electrode active material is more preferably synthesized by mixing the element into the transition metal oxide so that the molar ratio of Li/M^{a} reaches 0.3 to 2.2.

Specific examples of the transition metal oxides include transition metal oxides having a bedded salt-type structure (MA), transition metal oxides having a spinel-type structure (MB), lithium-containing transition metal phosphoric acid compounds (MC), lithium-containing transition metal halogenated phosphoric acid compounds (MD), lithium-containing transition metal silicate compounds (ME), and the like.

Specific examples of the transition metal oxides having a bedded salt-type structure (MA) include LiCoO₂ (lithium cobalt oxide [LCO]), LiNi₂O₂ (lithium nickelate) LiNi_{0.85}Co_{0.10}Al_{0.05}O₂ (lithium nickel cobalt aluminum oxide [NCA]), LiNi_{1/3}Co_{1/3}Mn_{1/3}O₂ (lithium nickel manganese cobaltate [NMC]), and LiNi_{0.5}Mn_{0.5}O₂ (lithium manganese nickelate).

Specific examples of the transition metal oxides having a spinel-type structure (MB) include LiMn₂O₄ (LMO), LiCoMnO₄, Li₂FeMn₃O₈, Li₂CuMn₃O₈, Li₂CrMn₃O₈, and Li₂NiMn₃O₈.

Examples of the lithium-containing transition metal phosphoric acid compounds (MC) include olivine-type iron phosphate salts such as LiFePO₄ and Li₃Fe₂(PO₄)₃, iron pyrophosphates such as LiFeP₂O₇, and cobalt phosphates such as LiCoPO₄, and monoclinic nasicon-type vanadium phosphate salt such as Li₃V₂(PO₄)₃ (lithium vanadium phosphate).

Examples of the lithium-containing transition metal halogenated phosphoric acid compounds (MD) include iron fluorophosphates such as Li₂FePO₄F, manganese fluorophosphates such as Li₂MnPO₄F, cobalt fluorophosphates such as Li₂CoPO₄F.

Examples of the lithium-containing transition metal silicate compounds (ME) include Li₂FeSiO₄, Li₂MnSiO₄, Li₂CoSiO₄, and the like.

In the present invention, a transition metal oxide having a (MA) bedded salt-type structure is preferred, and LCO or NMC is more preferred.

The positive electrode active material may be used singly or two or more positive electrode active materials may be used in combination.

In a case where the positive electrode active material layer is formed, the mass (mg) (basis weight) of the positive electrode active material per unit area (cm²) of the positive electrode active material layer is not particularly limited. The mass can be determined appropriately according to the designed battery capacity.

—Negative Electrode Active Material—

The negative electrode active material capable of reversibly inserting and releasing lithium ions is preferred. The materials are not particularly limited as long as the materials have the above characteristics, and examples thereof include carbon materials, metal oxides such as tin oxides, silicon oxides, metal complex oxides, lithium alloys such as elemental lithium and a lithium aluminum alloy, metals capable of forming an alloy with lithium, such as Sn, Si, Al and In, and the like. Among these, a carbon material or elemental lithium is preferred. Furthermore, metal complex oxides occluding and releasing lithium are preferred. Materials thereof are not particularly limited, but preferably contain titanium and/or lithium as a component from the viewpoint of high current density charging and discharging characteristics.

A carbon material used as the negative electrode active material is a material substantially consisting of carbon. Examples thereof include petroleum pitch, carbon black such as acetylene black (AB), graphite (natural graphite, scale graphite powder, artificial graphite such as vapor-grown graphite, or the like), and carbon materials obtained by firing various synthetic resins such as a PAN (polyacrylonitrile)-based resin and a furfuryl alcohol resin. Furthermore, examples thereof also include various carbon fibers such as PAN-based carbon fiber, cellulose-based carbon fiber, pitch-based carbon fiber, vapor-grown carbon fiber, dehydrated PVA (polyvinyl alcohol)-based carbon fiber, lignin carbon fiber, glassy carbon fiber, and activated carbon fiber, mesophase microspheres, graphite whiskers, flat graphite, and the like.

As metal oxides and metal complex oxides applied as the negative electrode active material, amorphous oxides are particularly preferred, and furthermore chalcogenide that is a reaction product of a metal element with an element belonging to Group XVI of the periodic table is also preferably used. The term “amorphous” described herein refers to oxides having a broad scattering band having a peak of a 2θ value in a range of 20° to 40° in an X-ray diffraction method in which CuKα rays are used and may have crystalline diffraction lines.

In a compound group consisting of the amorphous oxides and the chalcogenides, amorphous oxides of metalloid elements and chalcogenides are more preferred, and oxides consisting of one element or a combination of two or more elements selected from elements of Al, Ga, Si, Sn, Ge, Pb, Sb, and Bi belonging to Groups XIII (IIIB) to XV (VB) of the periodic table, and chalcogenides are particularly preferred. Specific examples of preferable amorphous oxides and chalcogenides preferably include Ga₂O₃, SiO, GeO, SnO, SnO₂, PbO, PbO₂, Pb₂O₃, Pb₂O₄, Pb₃O₄, Sb₂O₃, Sb₂O₄, Sb₂O₈Bi₂O₃, Sb₂O₈Si₂O₃, Bi₂O₄, SnSiO₃, GeS, SnS, SnS₂, PbS, PbS₂, Sb₂S₃, Sb₂S₅, and SnSiS₃. Furthermore, examples thereof may include a complex oxide with lithium oxide, for example, Li₂SnO₂.

It is also preferable that the negative electrode active material contains a titanium atom. More specifically, Li₄Ti₅O₁₂ (lithium titanium oxide [LTO]) is preferred since the volume fluctuation during occlusion and release of lithium ions is small, and thus the high-speed charging and discharging characteristics are excellent, and deterioration of electrodes is suppressed, whereby the service lives of lithium ion secondary batteries can be improved.

In the present invention, it is also preferable to use a Si-based negative electrode. Generally, a Si negative electrode can occlude more Li ions than a carbon negative electrode (such as graphite and acetylene black). That is, the amount of occluded Li ions per unit mass increases. Therefore, the battery capacity can be increased. As a result, there is an advantage that the battery driving time can be extended.

The chemical formulae of compounds obtained using the firing method can be calculated using an inductively coupled plasma (ICP) emission spectroscopic analysis method as a measurement method or, as a convenient method, from the mass difference of powder before and after firing.

The negative electrode active material may be used singly or two or more negative electrode active materials may be used in combination.

In a case where the negative electrode active material layer is formed, the mass (mg) (basis weight) of the negative electrode active material per unit area (cm²) of the negative electrode active material layer is not particularly limited. The mass can be determined appropriately according to the designed battery capacity.

The surfaces of the positive electrode active material and the negative electrode active material may be coated with a separate metal oxide. Examples of the surface coating agent include metal oxides and the like containing Ti, Nb, Ta, W, Zr, Al, Si, or Li. Specific examples thereof include titanium oxide spinel, tantalum-based oxides, niobium-based oxides, lithium niobite-based compounds, and the like, and specific examples thereof include Li₄Ti₅O₁₂, Li₂Ti₂O, LiTaO₃, LiNbO₃, LiAlO₂, Li₂ZrO₃, Li₂WO₄, Li₂TiO₃, Li₂B₄O₇, Li₃PO₄, Li₂MoO₄, Li₃BO₃, LiBO₂, Li₂CO₃, Li₂SiO₃, SiO₂, TiO₂, ZrO₂, Al₂O₃, B₂O₃, and the like.

In addition, a surface treatment may be carried out on the surfaces of electrodes including the positive electrode active material or the negative electrode active material using sulfur, phosphorous, or the like.

Furthermore, the surface of the particles of the positive electrode active material or the negative electrode active material may be subjected to a surface treatment with an active ray or an active gas (plasma or the like) before and after the surface coating.

(Inorganic Solid Electrolyte (B))

The electrode active material layer in the present invention contains an inorganic solid electrolyte (B).

In this specification, the “inorganic solid electrolyte (B)” is also simply referred to as an “inorganic solid electrolyte”.

The inorganic solid electrolyte is a solid electrolyte having inorganic properties, and the solid electrolyte refers to a solid-form electrolyte capable of migrating ions therein. The inorganic solid electrolyte is clearly differentiated from organic solid electrolytes (high-molecular-weight electrolytes represented by polyethylene oxide (PEO) or the like and organic electrolyte salts represented by lithium bis(trifluoromethanesulfonyl)imide (LiTFSI)) since the inorganic solid electrolyte does not include any organic substances as a principal ion conductive material. In addition, the inorganic solid electrolyte is a solid in a static state, and thus, generally is not disassociated or liberated into cations and anions. Due to this fact, the inorganic solid electrolyte is also clearly differentiated from inorganic electrolyte salts of which cations and anions are disassociated or liberated in electrolytic solutions or polymers (LiPF₆, LiBF₄, LiFSI, LiCl, and the like). The inorganic solid electrolyte is not particularly limited as long as the inorganic solid electrolyte has conductivity of an ion of a metal belonging to Group I or II of the periodic table and is generally a substance not having electron conductivity.

In the present invention, the inorganic solid electrolyte is a particle having ion conductivity of metals belonging to Group I or II of the periodic table and a median diameter of Rₛₑ. As the inorganic solid electrolyte, it is possible to appropriately select and use solid electrolyte materials that are applied to these kinds of products. Representative examples of the inorganic solid electrolyte include (i) a sulfide-based inorganic solid electrolyte and (ii) an oxide-based inorganic solid electrolyte. In the present invention, a sulfide-based inorganic solid electrolyte is preferably used from the viewpoint that a better interface can be formed between an active material and an inorganic solid electrolyte.

(i) Sulfide-Based Inorganic Solid Electrolytes

Sulfide-based inorganic solid electrolytes are preferably compounds which contain sulfur atoms (S), have ion conductivity of metals belonging to Group I or II of the periodic table, and have electron-insulating properties. The sulfide-based inorganic solid electrolytes are preferably inorganic solid electrolytes which, as elements, contain at least Li, S, and P and have lithium ion conductivity, but the sulfide-based inorganic solid electrolytes may also include elements other than Li, S, and P depending on the purposes or cases.

For example, lithium ion conductive inorganic solid electrolyte satisfying a composition represented by Formula (I) is exemplified.

Lₐ₁M_{b1}P_{c1}S_{d1}Aₑ₁ Formula (I)

In the formula, L represents an element selected from Li, Na, and K and is preferably Li. M represents an element selected from B, Zn, Sn, Si, Cu, Ga, Sb, Al, and Ge. A represents an element selected from I, Br, Cl, and F. a1 to e1 represent the compositional ratios among the respective elements, and a1:b1:c1:d1:e1 satisfies 1 to 12:0 to 5:1:2 to 12:0 to 10. a1 is preferably 1 to 9 and more preferably 1.5 to 7.5. b1 is preferably 0 to 3 and more preferably 0 to 1. d1 is preferably 2.5 to 10 and more preferably 3.0 to 8.5. e1 is preferably 0 to 5 and more preferably 0 to 3.

The compositional ratios among the respective elements can be controlled by adjusting the ratios of raw material compounds blended to manufacture the sulfide-based inorganic solid electrolyte as described below.

The sulfide-based inorganic solid electrolytes may be non-crystalline (glass) or crystallized (made into glass ceramic) or may be only partially crystallized. For example, it is possible to use Li—P—S-based glass containing Li, P, and S or Li—P—S-based glass ceramic containing Li, P, and S.

The sulfide-based inorganic solid electrolytes can be manufactured by a reaction of at least two or more raw materials of, for example, lithium sulfide (Li₂S), phosphorus sulfide (for example, diphosphorus pentasulfide (P₂S₅)), a phosphorus single body, a sulfur single body, sodium sulfide, hydrogen sulfide, lithium halides (for example, LiI, LiBr, and LiCl), or sulfides of an element represented by M (for example, SiS₂, SnS, and GeS₂).

The ratio between Li₂S and P₂S₅ in Li—P—S-based glass and Li—P—S-based glass ceramic is preferably 60:40 to 90:10 and more preferably 68:32 to 78:22 in terms of the molar ratio between Li₂S:P₂S₅. In a case in which the ratio between Li₂S and P₂S₅ is set in the above described range, it is possible to increase the lithium ion conductivity. Specifically, the lithium ion conductivity can be preferably set to 1×10⁻⁴ S/cm or more and more preferably set to 1×10⁻³ S/cm or more. The upper limit is not particularly limited, but realistically 1×10⁻¹ S/cm or less.

As specific examples of the sulfide-based inorganic solid electrolytes, combination examples of raw materials will be described below. Examples thereof include Li₂S—P₂S₅, Li₂S—P₂S₅—LiCl, Li₂S—P₂S₅—H₂S, Li₂S—P₂S₅—H₂S—LiCl, Li₂S—LiI—P₂S₅, Li₂S—LiI—Li₂O—P₂S₅, Li₂S—LiBr—P₂S₅, Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S—SiS₂—LiCl, Li₂S—P₂S₅—SnS, Li₂S—P₂S₅—Al₂S₃, Li₂S—GeS₂, Li₂S—GeS₂—ZnS, Li₂S—Ga₂S₃, Li₂S—GeS₂—Ga₂S₃, Li₂S—GeS₂—P₂S₅, Li₂S—GeS₂—Sb₂S₅, Li₂S—GeS₂—Al₂S₃, Li₂S—SiS₂, Li₂S—Al₂S₃, Li₂S—SiS₂—Al₂S₃, Li₂S—SiS₂—P₂S₅, Li₂S—SiS₂—P₂S₅—LiI, Li₂S—SiS₂—LiI, Li₂S—SiS₂—Li₄SiO₄, Li₂S—SiS₂—Li₃PO₄, Li₁₀GeP₂S₁₂, and the like. Mixing ratios of the respective raw materials do not matter. Examples of a method of synthesizing sulfide-based inorganic solid electrolyte materials using the above described raw material compositions include an amorphorization method. Examples of the amorphorization method include a mechanical milling method, a solution method, and a melting quenching method. This is because treatments at a normal temperature become possible, and it is possible to simplify manufacturing steps.

(ii) Oxide-Based Inorganic Solid Electrolytes

Oxide-based inorganic solid electrolytes are preferably compounds which contain oxygen atoms (O), have ion conductivity of metals belonging to Group 1 or II of the periodic table, and have electron-insulating properties.

Specific examples of the compounds include LiₓₐLa_{ya}TiO₃ [xa=0.3 to 0.7 and ya=0.3 to 0.7] (LLT), Li_{xb}La_{yb}Zr_{zb}M^{bb}_{mb}O_{nb} (M^{bb} is at least one element of Al, Mg, Ca, Sr, V, Nb, Ta, Ti, Ge, In or Sn, xb satisfies 5≤xb≤10, yb satisfies 1≤yb≤4, zb satisfies 1≤zb≤4, mb satisfies 0≤mb≤2, and nb satisfies 5≤nb≤20), Li_{xc}B_{yc}M^{cc}_{zc}O_{nc} (M^{cc} is at least one element of C, S, Al, Si, Ga, Ge, In, or Sn, xc satisfies 0≤xc≤5, yc satisfies 0≤yc≤1, zc satisfies 0≤zc≤1, and nc satisfies 0≤nc≤6), Li_{xd}(Al,Ga)_{yd}(Ti, Ge)_{zd}Si_{ad}P_{md}O_{nd} (1≤xd≤3, 0≤yd≤1, 0≤zd≤2, 0≤ad≤1, 1≤md≤7, 3≤nd≤13), Li_{(3-2xc)}M^{cc}_{xc}D^{cc}O (xe represents a number of 0 or more and 0.1 or less, and M^{cc} represents a divalent metal atom. D^{cc} represents a halogen atom or a combination of two or more halogen atoms), Li_{xf}Si_{yf}O_{zf} (1≤xf≤5, 0<yf≤3, 1≤zf≤10), Li_{xg}S_{yg}O_{zg} (1≤xg≤3, 0≤yg≤2, 1≤zg≤10), Li₃BO₃—Li₂SO₄, Li₂O—B₂O₃—P₂O₅, Li₂O—SiO₂, Li₆BaLa₂Ta₂O₁₂, Li₃PO_{(4-3/2w)}N_{w} (w satisfies w≤1), Li_{3.5}Zno_{0.25}GeO₄ having a lithium super ionic conductor (LISICON)-type crystal structure, La_{0.55}Li_{0.35}TiO₃ having a perovskite-type crystal structure, LiTi₂P₃O₁₂ having a natrium super ionic conductor (NASICON)-type crystal structure, Li_{1+xh+yh}(Al,Ga)ₓₕ(Ti,Ge)₂₋ₓₕSi_{yh}P_{3-yh}O₁₂ (0≤xh≤1, 0≤yh≤1), Li₇La₃Zr₂O₁₂ (LLZ) having a garnet-type crystal structure. In addition, phosphorus compounds containing Li, P, and O are also desirable. Examples thereof include lithium phosphate (Li₃PO₄), LiPON in which some of oxygen atoms in lithium phosphate are substituted with nitrogen, LiPOD¹ (D¹ is at least one element selected from Ti, V, Cr, Mn, Fe, Co, Ni, Cu, Zr, Nb, Mo, Ru, Ag, Ta, W, Pt, Au, or the like), and the like. It is also possible to preferably use LiA¹ON (A¹ represents at least one element selected from Si, B, Ge, Al, C, Ga, or the like) and the like.

The total content of an inorganic solid electrolyte and an active material in a solid component of an electrode active material layer in a solid electrolyte composition is not particularly limited, and when considering a reduction of interface resistance when the all-solid state secondary battery is used and maintenance of the reduced interface resistance, the content is preferably 5% by mass or more of 100% by mass of a solid component, more preferably 10% by mass or more, and particularly preferably 20% by mass. The upper limit is preferably 99.9% by mass or less, more preferably 99.5% by mass or less, and particularly preferably 99% by mass or less from the same viewpoint.

The inorganic solid electrolyte may be used singly or two or more inorganic solid electrolytes may be used in combination.

In the present specification, the term “solid content (solid component)” refers to a component which does not disappear by volatilization or evaporation when the solid electrolyte composition is dried at 170° C. for 6 hours under a nitrogen atmosphere. Typically, the solid content refers to components other than a dispersant described later.

(Conductive Particles (C))

A conductor layer in the present invention contains conductive particles (C). Examples of the conductive particles (C) include conductive inorganic particles such as metal particles and carbon particles (C1) described later.

Examples of the conductive inorganic particles preferably include aluminum, silver, copper, indium oxide, tin, tin oxide, and titanium oxide.

The content of the conductive particles in an all-solid state component constituting the conductor layer in the present invention is not particularly limited, but is preferably 30% by mass or more, more preferably 60% by mass or more, and the upper limit may be 100% by mass and is preferably 90% by mass or less.

The conductive particles may be used singly or two or more conductive particles may be used in combination.

The conductive particles preferably include carbon particles (C1). Hereinafter, the term “carbon particles (C1)” may be simply referred to as “carbon particles”.

Specific examples of the carbon particles (C1) include denka black, carbon black, carbon nanotube, graphite, and the like.

An average particle diameter (particle diameter) of the carbon particles (Cl) is selected in accordance with the above described adjustment of Rz, and is preferably 0.1 μm or more and 20 μm or less, more preferably 0.2 μm or more and 15 μm or less, and particularly preferably 0.5 μm or more and 10 μm or less. The average particle diameter of the carbon particles (C1) is a value obtained by a measurement method described in Example.

The average particle diameter of the conductive inorganic particles and the method of measuring the same are the same as the carbon particles (C1).

The content of the metal particles and/or carbon particles (C1) in the conductive particles is preferably 80% by mass, more preferably 90% by mass, and may be 100% by mass.

(Binder (D))

The conductor layer in the present invention preferably contains a binder (D).

The binder (D) is not particularly limited as long as the binder has an affinity for an electrode collector and has an affinity for materials for forming a conductor layer (for example, the conductive particles (C)).

As the binder (D), for example, resin materials such as rubber, a thermoplastic elastomer, a hydrocarbon resin, a silicone resin, an acrylic resin, fluoro rubber, and the like can be used.

Specific examples of the rubber include hydrocarbon rubber (butadiene rubber, styrene-butadiene rubber, acrylonitrile-butadiene rubber, or hydrogenated rubber thereof), fluoro rubber (polyvinylene difluoride (PVdF), copolymers of vinylidene fluoride and hexafluoropropylene, polytetrafluoroethylene (PTFE), and the like), cellulose rubber, and acrylic rubber (such as acrylic ester, and the like).

Specific examples of the thermoplastic elastomer include copolymers of styrene, ethylene, and butylene, olefin-based elastomers, urethane-based elastomers, ester-based elastomers, and amide-based elastomers. Elastomer means a resin containing so-called hard segments and soft segments.

Specific examples of the hydrocarbon resin include styrene-butadiene and polyolefin. The hydrocarbon resin is a resin in which at least one component is a hydrocarbon compound component, and means a resin other than rubber and other than a thermoplastic elastomer.

Among these, the binder having an affinity for a non-polar solvent is preferred.

The conductor layer in the present invention contains a binder having an affinity for a non-polar solvent as the binder (D), whereby a dispersion solvent (non-polar solvent) of an electrode composition penetrates into the conductor layer in a case where the electrode composition is applied to a surface of the conductor layer, and a binder having an affinity for the non-polar solvent diffuses and moves from the conductor layer to the electrode composition forming an electrode active material layer. That is, the binder having an affinity for the non-polar solvent bleeds out the electrode active material layer, and binding properties between the electrode active material layer and the conductor layer becomes firm.

As the binder having an affinity for the non-polar solvent, a hydrocarbon resin, an acrylic resin, rubber, and a thermoplastic elastomer are preferred, a hydrocarbon resin, hydrocarbon rubber, and an acrylic resin are more preferred, and a hydrocarbon resin is particularly preferred.

In the present invention, a structure of the compound constituting the binder (D) is preferably different from a structure of a compound constituting binder particles (E) described later in order to maintain a state where the electrode resistance is further reduced.

The binder (D) may be used singly or two or more binders (D) may be used in combination.

A shape of the binder (D) is an irregular shape in the electrode sheet for an all-solid state secondary battery or an all-solid state secondary battery.

The binder (D) is preferably a particulate polymer of 0.05 to 50 μm in order to suppress formation of a resistive film generated by being coated with an active material or an inorganic solid electrolyte.

An average particle diameter of the binder (D) used in the present invention can be calculated in the same manner as an average particle diameter of the binder particles (E) described later.

The compound constituting the binder (D) used in the present invention preferably has a moisture concentration of 100 ppm (on a mass basis) or less.

Furthermore, the compound constituting the binder (D) used in the present invention may be used in a solid state, or may be used in a dispersion liquid state or a solution state of the compound.

The compound constituting the binder (D) used in the present invention has a mass average molecular weight of preferably 5,000 or more, more preferably 10,000 or more, and even more preferably 20,000 or more. The upper limit is preferably 1,000,000 or less, more preferably 200,000 or less, and even more preferably 100,000.

—Measurement of Molecular Weight—

In the present invention, unless otherwise specified, the “molecular weight” of the binder (D) and the binder particles (E) refers to a mass average molecular weight, and a mass average molecular weight of standard polystyrene conversion is measured by gel permeation chromatography (GPC). A value which is measured using the method of condition A or condition B (priority) below as the measurement method is set as a base. Here, depending on kinds of the binder (D) and the binder particles (E), a suitable eluent may be appropriately selected and used.

(Condition A)
Column: Two pieces of TOSHO TSKgel Super AWM-H (trade name) are connected to each other
Carrier: 10 mM LiBr/N-methylpyrrolidone
Measurement temperature: 40° C.
Carrier flow rate: 1.0 mL/min
Specimen concentration: 0.1% by mass
Detector: RI (refractive index) detector

(Condition B) Priority
Column: Column to which TOSOH TSKgel Super HZM-H (trade name), TOSOH TSKgel Super HZ4000 (trade name), or TOSOH TSKgel Super HZ2000 (trade name) is connected is used.
Carrier: Tetrahydrofuran
Measurement temperature: 40° C.
Carrier flow rate: 1.0 mL/min
Specimen concentration: 0.1% by mass
Detector: RI (refractive index) detector

The content of the binder (D) in the conductor layer is preferably 0.1% by mass or more, more preferably 1% by mass or more, even more preferably 3% by mass or more, in consideration of reduction of the excellent interface resistance, and maintenance thereof when used in an all-solid state secondary battery. From the viewpoint of battery characteristics, the upper limit is preferably 90% by mass or less, more preferably 80% by mass or less, and even more preferably 70% by mass or less.

(Binder Particles (E))

The electrode active material layer in the present invention may contain binder particles (E) having an average particle diameter of 1 nm to 10 μm.

The binder particles (E) used in the present invention are not particularly limited as long as the binder particles (E) are compound particles having an average particle diameter of 1 nm to 10 μm. Specific examples thereof include particles of the following compounds.

Examples of fluorine-containing resins include polytetrafluoroethylene (PTFE), polyvinylene difluoride (PVdF), and a copolymer of polyvinylene difluoride and hexafluoropropylene (PVdF-HFP).

Examples of hydrocarbon resins and rubber include polyethylene, polypropylene, styrene butadiene rubber (SBR), hydrogenated styrene butadiene rubber (HSBR), butylene rubber, acrylonitrile butadiene rubber, polybutadiene, polyisoprene, and the like.

Examples of acrylic resins include various (meth)acrylic monomers, (meth)acrylic acid ester monomers, (meth)acrylamide monomers, and copolymers of monomers constituting these resins (specifically, copolymers of (meth)acrylic acid and (meth)acrylic acid alkyl ester (preferably acrylic acid and methyl acrylate)).

Copolymers with other vinyl monomers are also suitably used. Examples thereof include copolymers of methyl (meth)acrylate and polystyrene, copolymers of methyl (meth)acrylate and acrylonitrile, and copolymers of butyl (meth)acrylate, acrylonitrile, and styrene.

In the specification of the present application, a copolymer may be any one of a statistic copolymer, a periodic copolymer, a blocked copolymer, and a graft copolymer, and a blocked copolymer is preferred.

Examples of other compounds include urethane resins, polyurea, polyamide, polyimide, polyester resins, polyether resins, polycarbonate resins, and cellulose derivative resins.

The compound may be used singly or two or more compounds may be used in combination.

The binder particles (E) are preferably at least one kind of particles of the above described polyamide, polyimide, polyurea, fluorine-containing resins, hydrocarbon resins, urethane resins, and acrylic resins in order to further enhance the binding properties between inorganic solid electrolytes, between active materials, and between the inorganic solid electrolyte and the active material.

In the present invention, the binder particles (E) preferably have at least one of the following functional groups.

<Group of Functional Groups>

An acidic functional group, a basic functional group, a hydroxy group, a cyano group, an alkoxysilyl group, an aryl group, a heteroaryl group, and a hydrocarbon ring group three or more rings are fused.

Examples of the acidic functional group include a carboxylic acid group (—COOH), a sulfonic acid group (sulfo group: —SO₃H), a phosphoric acid group (phospho group: —OPO (OH)₂), a phosphonic acid group, and a phosphinic acid group.

Examples of the basic functional group include an amino group, a pyridyl group, an imino group, and an amidine.

The alkoxysilyl group preferably has 1 to 6 carbon atoms, and examples thereof include methoxysilyl, ethoxysilyl, t-butoxysilyl, and cyclohexylsilyl.

The number of carbon atoms constituting the ring of the aryl group is preferably 6 to 10, and examples thereof include phenyl and naphthyl. The ring of the aryl group is a single ring or a ring in which two rings are fused.

The heterocycle of the heteroaryl group is preferably a 4-membered to 10-membered ring, and the heterocycle preferably has 3 to 9 carbon atoms. Hetero atoms constituting the heterocycle include, for example, an oxygen atom, a nitrogen atom and a sulfur atom. Specific examples of the heterocycle include thiophene, furan, pyrrole, and imidazole.

The hydrocarbon ring group in which three or more rings are fused is not particularly limited as long as the hydrocarbon ring is a ring group in which three or more rings are fused. Examples of the hydrocarbon ring that is fused include a saturated aliphatic hydrocarbon ring, an unsaturated aliphatic hydrocarbon ring, and an aromatic hydrocarbon ring (benzene ring). The hydrocarbon ring is preferably a five-membered ring or a six-membered ring.

The hydrocarbon ring group in which three or more rings are fused is preferably a ring group in which three or more rings are fused and which includes at least one aromatic hydrocarbon ring or a ring group in which three or more saturated aliphatic hydrocarbon rings or unsaturated aliphatic hydrocarbon rings are fused.

The number of rings that are fused is not particularly limited, but is preferably 3 to 8 and more preferably 3 to 5.

The ring group in which three or more rings are fused and which includes at least one aromatic hydrocarbon ring is not particularly limited, and examples thereof include ring groups made of anthracene, phenanthracene, pyrene, tetracene, tetraphene, chrysene, triphenylene, pentacene, pentaphene, perylene, pyrene, benzo[a]pyrene, coronene, antanthrene, corannulene, ovalene, graphene, cycloparaphenylene, polyparaphenylene, or cyclophen.

The ring group in which three or more saturated aliphatic hydrocarbon rings or unsaturated aliphatic hydrocarbon rings are fused is not particularly limited, and examples thereof include ring groups made of a compound having a steroid skeleton. Examples of the compound having a steroid skeleton include ring groups made of a compound of cholesterol, ergosterol, testosterone, estradiol, aldosterone, hydrocortisone, stigmasterol, thymosterol, lanosterol, 7-dehydrodesmosterol, 7-dehydrocholesterol, cholanic acid, cholic acid, lithocholic acid, deoxycholic acid, sodium deoxycholate, lithium deoxycholate, hydrodeoxycholic acid, chenodeoxycholic acid, ursodeoxycholic acid, dehydrocholic acid, hococholic acid, or hyocholic acid.

As the hydrocarbon ring group in which three or more rings are fused, among the above described ring groups, the ring group consisting of a compound having a cholesterol ring structure or a pyrenyl group is more preferred.

The functional group exhibits a function of interacting with solid particles such as an inorganic solid electrolyte and/or an active material and adsorbing these particles and the binder particles (E). This interaction is not particularly limited, and examples thereof include an interaction by a hydrogen bond, an interaction by an ionic bond between an acid and a base, an interaction by a covalent bond, an interaction by a π-π interaction by an aromatic ring, an interaction by a hydrophobic-hydrophobic interaction, and the like. The solid particles and the binder particles (E) are adsorbed to each other by one or two more of the above described interactions depending on the kind of the functional group and the kind of the above-described particles.

In a case where the functional group interacts, as described above, the chemical structure of the functional group may or may not change. For example, in the 7t-7t interaction and the like, generally, the functional group does not change and maintains its original structure. On the other hand, in the interaction by a covalent bond or the like, generally, the functional group turns into an anion from which active hydrogen such as a carboxylic acid group is desorbed (the functional group changes) and bonds to the inorganic solid electrolyte.

A carboxylic acid group, a sulfonic acid group, a phosphoric acid group, a hydroxy group, a cyano group, and an alkoxysilyl group are suitably adsorbed to a positive electrode active material and the inorganic solid electrolyte. Among these, a carboxylic acid group is particularly preferred.

An aryl group, a heteroaryl group, and an aliphatic hydrocarbon ring group in which three or more rings are fused are suitably adsorbed to a negative electrode active material and a conductive auxiliary agent. Among these, a hydrocarbon ring group in which three or more rings are fused is particularly preferred.

An average particle diameter of the binder particles (E) is 1 nm to 10 μm, preferably 1 nm to 500 nm, and more preferably 10 nm to 400 nm in order to further improve the contact of the solid interface between the active materials in the active material layer, between the inorganic solid electrolytes, and/or between the inorganic solid electrolyte and the active material.

The average particle diameter of the binder particles (E) is calculated by the following method. 1% by mass of a dispersion liquid is diluted and prepared using the binder particles (E) and any of dispersant (a dispersant used for preparing a solid electrolyte composition, for example, heptane) in a 20 mL sample bottle. The diluted dispersion specimen is irradiated with 1 kHz ultrasonic waves for 10 minutes and is then immediately used for testing. Data capturing is carried out 50 times using this dispersion liquid specimen, a laser diffraction/scattering-type particle size distribution measurement instrument LA-920 (trade name, manufactured by Horiba Ltd.), and a quartz cell for measurement at a temperature of 25° C., whereby the obtained volume average particle diameter is used as an average particle diameter. Regarding other detailed conditions and the like, the description of JIS Z 8828:2013 “particle diameter analysis-Dynamic light scattering method” is referred to as necessary. Five specimens are produced and measured per level, and the average values thereof are employed.

The measurement for the produced all-solid state secondary battery can be performed by, for example, measuring the electrode material according to the measurement method of the above described average particle diameter of the binder particles (E) after disassembling the battery and peeling off the electrode, and then excluding the measured values of the average particle diameter of particles other than the binder particles (E) measured in advance.

A mass average molecular weight of the binder particles (E) is preferably 5,000 or more and less than 5,000,000, more preferably 5,000 or more and less than 500,000, even more preferably 5,000 or more and less than 100,000.

The upper limit of the glass transition temperature of the binder particles (E) is preferably 80° C. or lower, more preferably 50° C. or lower, and even more preferably 30° C. or lower. The lower limit is not particularly limited, but is generally −80° C. or higher.

The binder particles (E) may be used in a solid state and may be used in a particle dispersion, and is preferably used in a particle dispersion.

The content of the binder particles (E) in the electrode active material layer is preferably 0.01% by mass or more with respect to 100% by mass of the solid component, more preferably 0.1% by mass or more, and even more preferably 1% by mass or more, from the viewpoint of compatibility between binding properties with the solid particles and ion conductivity. From the viewpoint of battery characteristics, the upper limit is preferably 20% by mass or less, more preferably 10% by mass or less, and even more preferably 7% by mass or less.

In the electrode active material layer of the present invention, a mass ratio of the total mass (the total amount) of the inorganic solid electrolyte and the active material to the mass of the binder particles (E) [(Mass of inorganic solid electrolyte+Mass of active material)/(Mass of binder particles (E))] is preferably in a range of 1,000 to 1. Furthermore, this ratio is more preferably in a range of 500 to 2, and even more preferably 100 to 10.

(Dispersant)

The electrode active material layer in the present invention may also contain a dispersant. The addition of a dispersant suppresses the agglomeration of the electrode active material or the inorganic solid electrolyte even in a case where the concentration of any one of the electrode active material or the inorganic solid electrolyte is high and/or the particle diameters of the electrode active material and the inorganic solid electrolyte are small so that surface areas increase and enables the formation of uniform active material layers. As the dispersant, a dispersant commonly used for an all-solid state secondary battery can be appropriately selected and used. Generally, a compound intended for particle adsorption and steric repulsion and/or electrostatic repulsion is suitably used.

(Lithium Salt)

The electrode active material layer of the invention may also contain a lithium salt.

The lithium salt is not particularly limited, and, for example, the lithium salt described in paragraphs 0082 to 0085 of JP2015-088486A is preferred.

The content of the lithium salt is preferably 0 parts by mass or more, more preferably 5 parts by mass or more with respect to 100 parts by mass of the inorganic solid electrolyte.

The upper limit is preferably 50 parts by mass or less, and more preferably 20 parts by mass.

(Ionic Liquid)

The electrode active material layer in the present invention may contain ionic liquid in order to further improve ion conductivity. The ionic liquid is not particularly limited, but is preferably ionic liquid that dissolves the above described lithium salt from the viewpoint of effectively improving ion conductivity. Examples thereof include compounds made in combination of the following cation and an anion.

(i) Cation

Examples of the cation include an imidazolium cation, a pyridinium cation, a piperidinium cation, a pyrrolidinium cation, a morpholinium cation, a phosphonium cation, a quaternary ammonium cation, and the like. Here, these cations have the following substituent.

As the cation, these cations may be used singly or two or more cations may be used in combination.

A quaternary ammonium cation, a piperidinium cation, or a pyrrolidinium cation is preferred.

Examples of the substituent that the above-described cations have include an alkyl group (preferably an alkyl group having 1 to 8 carbon atoms and more preferably an alkyl group having 1 to 4 carbon atoms), a hydroxyalkyl group (preferably a hydroxyalkyl group having 1 to 3 carbon atoms), an alkyloxyalkyl group (preferably an alkyloxyalkyl group having 2 to 8 carbon atoms and more preferably an alkyloxyalkyl group having 2 to 4 carbon atoms), an ether group, an allyl group, an aminoalkyl group (preferably an aminoalkyl group having 1 to 8 carbon atoms and preferably an aminoalkyl group having 1 to 4 carbon atoms), and an aryl group (preferably an aryl group having 6 to 12 carbon atoms and more preferably an aryl group having 6 to 8 carbon atoms). The above described substituents may form a ring structure in a form of containing a cation site. The substituents may further have the substituent described in the section of the dispersant. The ether group is used in combination with a different substituent. Examples of the different substituent include an alkyloxy group, an aryloxy group, and the like.

(ii) Anion

Examples of the anion include a chloride ion, a bromide ion, an iodide ion, a boron tetrafluoride ion, a nitric acid ion, a dicyanamide ion, an acetate ion, an iron tetrachloride ion, a bis(trifluoromethanesulfonyl)imide ion, a bis(fluorosulfonyl)imide ion, a bis(perfluorobutylmethanesulfonyl)imide ion, an allylsulfonate ion, a hexafluorophosphate ion, a trifluoromethanesulfonate ion, and the like.

As the anion, these anions may be used singly or two or more anions may also be used in combination.

A boron tetrafluoride ion, a bis(trifluoromethanesulfonyl)imide ion, a bis(fluorosulfonyl)imide ion or a hexafluorophosphate ion, a dicyanamide ion, and an allylsulfonate ion are preferred, and a bis(trifluoromethanesulfonyl)imide ion or a bis(fluorosulfonyl)imide ion, and an allylsulfonate ion are more preferred.

Examples of the ionic liquid include 1-allyl-3-ethylimidazolium bromide, 1-ethyl-3-methylimidazolium bromide, 1-(2-hydroxyethyl)-3-methylimidazolium bromide, 1-(2-methoxyethyl)-3-methylimidazolium bromide, 1-octyl-3-methylimidazolium chloride, N,N-diethyl-N-methyl-N-(2-methoxyethyl)ammonium tetrafluoroborate, 1-ethyl-3-methylimidazolium bis(trifluoromethanesulfonyl)imide, 1-ethyl-3-methylimidazolium bis(fluorosulfonyl)imide, 1-ethyl-3-methylimidazolium dicyanamide, 1-butyl-1-methylpyrrolidinium bis(trifluoromethanesulfonyl)imide, trimethylbutylammonium bis(trifluoromethanesulfonyl)imide, N,N-diethyl-N-methyl-N-(2-methoxyethyl) ammonium bis(trifluoromethanesulfonyl)imide (DEME), N-propyl-N-methylpyrrolidium bis(trifluoromethanesulfonyl)imide (PMP), N-(2-methoxyethyl)-N-methylpyrrolidinium tetrafluoroboride, 1-butyl-1-methylpyrrolidinium bis(fluorosulfonyl)imide, (2-acryloylethyl) trimethylammonium bis(trifluoromethanesulfonyl)imide, 1-ethyl-1-methylpyrrolidinium allyl sulfonate, 1-ethyl-3-methylimidazolium allylsulfonate, and trihexyltetradecylphosphonium chloride.

The content of the ionic liquid is preferably 0 parts by mass or more, more preferably 1 part by mass or more, and most preferably 2 part by mass or more with respect to 100 parts by mass of the inorganic solid electrolyte. The upper limit is preferably 50 parts by mass or less, more preferably 20 parts by mass or less, and particularly preferably 10 parts by mass or less.

The mass ratio between the lithium salt and the ionic liquid (lithium salt:ionic liquid) is preferably 1:20 to 20:1, more preferably 1:10 to 10:1, and most preferably 1:7 to 2:1.

(Conductive Auxiliary Agent)

The electrode active material layer of the invention may also contain a conductive auxiliary agent. The conductive auxiliary agent is not particularly limited, and conductive auxiliary agents that are known as ordinary conductive auxiliary agents can be used. The conductive auxiliary agent may be, for example, electron conductivity materials such as natural graphite or artificial graphite, carbon black such as acetylene black, Ketjen black, or furnace black, irregular carbon such as needle cokes, a carbon fiber such as a vapor-grown carbon fiber or a carbon nanotube, or a carbon material such as graphene or fullerene and also may use metal powder or a metal fiber of copper, nickel, or the like, and a conductive polymer such as polyaniline, polypyrrole, polythiophene, polyacetylene, or a polyphenylene derivative. In addition, these conductive auxiliary agents may be used singly or two or more conductive auxiliary agents may be used.

The content of the conductive auxiliary agent in all the solid components constituting the electrode active material layer is preferably 0.5% to 5% by mass, and more preferably 1% to 3% by mass.

<Method of Manufacturing Electrode Sheet for all-Solid State Secondary Battery>

A method of manufacturing an electrode sheet for an all-solid state secondary battery according to the embodiment of the present invention is suitable as the method of manufacturing an all-solid state secondary battery according to the embodiment of the present invention.

The method of manufacturing an electrode sheet for an all-solid state secondary battery according to the embodiment of the present invention is

a method of manufacturing an electrode sheet for an all-solid state secondary battery, which includes, in the following order, a conductor layer containing conductive particles (C) and an electrode active material layer on at least one surface of an electrode collector, and

in which the electrode active material layer containing an active material (A) having a median diameter Rₐₘ and an inorganic solid electrolyte (B) having a median diameter Rₛₑ is provided on a surface of the conductor layer having a maximum height roughness Rz of 3.0 to 10 μm defined in JIS B 0601:2013, the manufacturing method includes:

a step of adjusting Rz with the conductive particles (C),

in which the above described Rₐₘ, Rₛₑ, and Rz satisfy the following Expressions (1) and (2).

0.15<Rz/Rₐₘ<90 Expression (1):

0.15<Rz/Rₛₑ<90 Expression (2):

Hereinafter, the steps included or may be included in the method of manufacturing an electrode sheet for an all-solid state secondary battery according to the embodiment of the present invention will be described in detail.

(Preparation of Composition for Forming Conductor Layer)

A composition for forming a conductor layer is prepared by stirring the conductive particles (C) in the presence of the dispersant to produce a slurry.

The slurry can be produced by mixing the conductive particles (C) and the dispersant using a variety of mixers. The mixer is not particularly limited, and examples thereof include a ball mill, a beads mill, a planetary mixer, a blade mixer, a roll mill, a kneader, and a disk mill. The mixing conditions are not particularly limited, but, in the case of using a ball mill, the conductive particles (C) and the dispersant are preferably mixed together at 150 to 700 rpm (rotation per minute) for five minutes to 24 hours. After mixing, the mixture may be filtered as necessary.

In a case of preparing a composition for forming a conductor layer containing a component such as a binder (D) in addition to the conductive particles (C), the composition may be added and mixed at the same time when a step of dispersing the conductive particles (C) is performed, or may be separately added and mixed.

The above Rz can be adjusted by the average particle diameter and/or content of the conductive particles (C).

(Preparation of Electrode Composition)

A electrode composition is prepared by dispersing the active material (A) and the inorganic solid electrolyte (B) in the presence of a dispersant and forming a slurry in the same manner as the composition for forming a conductor layer.

(Formation of Sheet)

A composition for forming a conductor layer is applied to an electrode collector and dried to form a conductor layer. Rz on a surface of the conductor layer is adjusted by an average particle diameter of conductive particles contained in the conductor layer.

The electrode composition is applied to the conductor layer, and heated and dried to form an electrode active material layer. The active material (A) and the inorganic solid electrolyte (B) contained in the electrode active material layer enter recessed portions on the surface of the conductor layer during formation of a laminate structure in this manner.

The description regarding formation of each layer described later can be applied to formation of the conductor layer and the electrode active material layer.

(Dispersant)

Specific examples of the dispersant used for preparing the composition for forming a conductor layer and the electrode composition include the following dispersants.

Examples of alcohol compound solvents include methyl alcohol, ethyl alcohol, 1-propyl alcohol, 2-butanol, ethylene glycol, propylene glycol, glycerin, 1,6-hexanediol, 1,3-butanediol, and 1,4-butanediol.

Examples of ether compound solvents include alkylene glycol alkyl ethers (ethylene glycol monomethyl ether, ethylene glycol monobutyl ether, diethylene glycol, dipropylene glycol, propylene glycol monomethyl ether, diethylene glycol monomethyl ether, triethylene glycol, polyethylene glycol, propylene glycol monomethyl ether, dipropylene glycol monomethyl ether, tripropylene glycol monomethyl ether, diethylene glycol monobutyl ether, diethylene glycol dibutyl ether, and the like), dialkyl ethers (dimethyl ether, diethyl ether, dibutyl ether, and the like), tetrahydrofuran, and dioxane (including 1,2-isomer, 1,3-isomer, and 1,4-isomer).

Examples of amide compound solvents include N,N-dimethylformamide, 1-methyl-2-pyrrolidone, 2-pyrrolidinone, 1,3-dimethyl-2-imidazolidinone, ε-caprolactam, formamide, N-methylformamide, acetamide,N-methylacetamide, N,N-dimethylacetamide, N-methylpropanamide, hexamethylphosphoric triamide, and the like.

Examples of amino compound solvents include triethylamine, and tributylamine.

Examples of ketone compound solvents include acetone, methyl ethyl ketone, diethyl ketone, dipropyl ketone, dibutyl ketone, and diisobutyl ketone.

Examples of ester-based compound solvents include methyl acetate, ethyl acetate, propyl acetate, butyl acetate, pentyl acetate, hexyl acetate, methyl propionate, ethyl propionate, propyl propionate, butyl propionate, methyl butyrate, ethyl butyrate, propyl butyrate, butyl butyrate, pentyl butyrate, methyl valerate, ethyl valerate, propyl valerate, butyl valerate, methyl caproate, ethyl caproate, propyl caproate, butyl caproate, and the like.

Examples of aromatic compound solvents include benzene, toluene, xylene, and mesitylene.

Examples of aliphatic compound solvents include hexane, heptane, cyclohexane, methylcyclohexane, ethylcyclohexane, octane, pentane, cyclopentane, and cyclooctane.

Examples of nitrile compound solvents include acetonitrile, propionitrile, and butyronitrile.

The boiling point of the dispersant at a normal pressure (1 atmosphere) is preferably 50° C. or higher and more preferably 70° C. or higher. The upper limit is preferably 250° C. or lower and more preferably 220° C. or lower. The dispersant may be used singly or two or more dispersants may be used in combination.

It is possible that Rz of the conductor layer included in the electrode sheet for an all-solid state secondary battery according to the embodiment of the present invention is adjusted by the average particle diameter and content of the conductive particles, and the average particle diameter and content of the binder (D). The electrode sheet for an all-solid state secondary battery according to the embodiment of the present invention can be manufactured by a conventional method except for the adjustment of Rz.

<Method of Manufacturing all-Solid State Secondary Battery>

A method of manufacturing the all-solid state secondary battery can be performed by an ordinary method as long as a method of manufacturing an electrode sheet for an all-solid state secondary battery is included. Specifically, the all-solid state secondary battery and the electrode sheet for an all-solid state secondary battery can be manufactured by forming the respective layers described above using a solid electrolyte composition, and the like. The details will be described below.

The all-solid state secondary battery according to the embodiment of the present invention can be manufactured by the following method.

The all-solid state secondary battery can be manufactured by a method including (through) a step of forming a conductor layer on a metal foil serving as an electrode collector using a composition for forming a conductor layer, applying an electrode composition on the conductor layer, and forming a coating film (film formation).

For example, a positive electrode sheet for an all-solid state secondary battery is produced by forming a conductor layer on a metal foil that is a positive electrode collector using a composition for forming a conductor layer, and forming a positive electrode active material layer on the conductor layer as a positive electrode composition, the positive electrode active material layer being formed by applying a solid electrolyte composition containing a positive electrode active material. Next, a solid electrolyte composition for forming a solid electrolyte layer is applied onto the positive electrode active material layer to form a solid electrolyte layer. Furthermore, a solid electrolyte composition containing a negative electrode active material is applied as a negative electrode composition onto the solid electrolyte layer to form a negative electrode active material layer. A negative electrode collector (a metal foil) is overlaid on the negative electrode active material layer, whereby it is possible to obtain an all-solid state secondary battery having a structure in which the solid electrolyte layer is disposed between the positive electrode active material layer and the negative electrode active material layer. As necessary, a desired all-solid state secondary battery can be manufactured by enclosing the all-solid state secondary battery in a housing.

Examples of other methods include the following methods. That is, a positive electrode sheet for an all-solid state secondary battery is produced as described above. In addition, a negative electrode sheet for an all-solid state secondary battery is produced by forming a conductor layer on a metal foil that is a negative electrode collector using a composition for forming a conductor layer, and forming a negative electrode active material layer on the conductor layer as a negative electrode composition, the negative electrode active material layer being formed by applying a solid electrolyte composition containing a negative electrode active material. Next, a solid electrolyte layer is formed on the active material layer of any one of these sheets as described above. Furthermore, the other one of the positive electrode sheet for an all-solid state secondary battery and the negative electrode sheet for an all-solid state secondary battery is laminated on the solid electrolyte layer so that the solid electrolyte layer and the active material layer come into contact with each other. Thus, the all-solid state secondary battery can be manufactured as described above.

In addition, examples of other methods include the following methods. That is, a positive electrode sheet for an all-solid state secondary battery and a negative electrode sheet for an all-solid state secondary battery are produced as described above. In addition, separately from the positive electrode sheet for an all-solid state secondary battery and the negative electrode sheet for an all-solid state secondary battery, a solid electrolyte composition is applied onto a base material, and thereby a solid electrolyte sheet for an all-solid state secondary battery consisting of a solid electrolyte layer is produced. Furthermore, the positive electrode sheet for an all-solid state secondary battery and the negative electrode sheet for an all-solid state secondary battery are laminated together so as to sandwich the solid electrolyte layer that has been peeled off from the base material. Thus, the all-solid state secondary battery can be manufactured as described above.

An all-solid state secondary battery can be manufactured by combining the above described forming methods. For example, as described above, a positive electrode sheet for an all-solid state secondary battery, a negative electrode sheet for an all-solid state secondary battery, and a solid electrolyte sheet for an all-solid state secondary battery are produced respectively. Next, a solid electrolyte layer that has been peeled off from the base material is laminated on the negative electrode sheet for an all-solid state secondary battery and is then attached to the positive electrode sheet for an all-solid state secondary battery, whereby an all-solid state secondary battery can be manufactured. In this method, it is also possible to laminate the solid electrolyte layer on the positive electrode sheet for an all-solid state secondary battery and attach the solid electrolyte layer to the negative electrode sheet for an all-solid state secondary battery.

(Formation of Respective Layers (Film Formation))

A method of applying a solid electrolyte composition is not particularly limited, and can be appropriately selected. Examples thereof include coating (preferably wet coating), spray coating, spin coating, dip coating, slit coating, stripe coating, and bar coating.

In this case, the solid electrolyte composition may be subjected to drying treatment after each application is performed, or may be subjected to drying treatment after applying multiple layers. The drying temperature is not particularly limited. The lower limit is preferably 30° C. or higher, more preferably 60° C. or higher, even more preferably 80° C. or higher. The upper limit is preferably 300° C. or lower, more preferably 250° C. or lower, and even more preferably 200° C. or lower. The composition is heated at such a temperature range, whereby a dispersant can be removed to obtain a solid state. Furthermore, it is preferable that the temperature is not too high and each member of the all-solid state secondary battery is not damaged. Thereby, the all-solid state secondary battery can exhibit excellent overall performance and can obtain good binding properties.

It is preferable to pressurize each layer or the all-solid state secondary battery after applying the respective compositions or after producing the all-solid state secondary battery. It is also preferable to pressurize each layer in a laminated state. As a pressurization method, a hydraulic cylinder press or the like can be used. Pressurizing force is not particularly limited, and is generally preferably in a range of 50 to 1500 MPa.

The applied solid electrolyte composition may be heated and pressurized simultaneously. The heating temperature is not particularly limited, and is generally in a range of 30° C. to 300° C. Pressing can be performed at a temperature higher than the glass transition temperature of the inorganic solid electrolyte.

Pressurization may be performed in a state where the applied solvent or the dispersant is dried in advance, or may be performed in a state where the solvent or the dispersant remains.

In addition, respective compositions may be applied simultaneously, and application, drying, and press may be performed simultaneously and/or sequentially. The respective compositions are applied to separate base materials, and then may be laminated by transcription.

The atmosphere during pressurization is not particularly limited, and may be in any environment such as in the atmosphere, under the dried air (the dew point: −20° C. or lower), in an inert gas (for example, in an argon gas, in a helium gas, or in a nitrogen gas).

The pressing time may be a short time (for example, within several hours) at a high pressure or a long time (one day or longer) under the application of an intermediate pressure.

In the case of members other than the electrode sheet for an all-solid state secondary battery, for example, the all-solid state secondary battery, it is also possible to use a restraining device (screw fastening pressure or the like) in order to continuously apply an intermediate pressure.

The pressing pressure may be uniform or different with respect to a pressure-receiving portion such as a sheet surface.

The pressing pressure can be changed depending on the area or film thickness of the pressure-receiving portion. In addition, it is also possible to apply different pressures gradedly to the same portion.

A pressing surface may be flat or roughened.

(Initialization)

The all-solid state secondary battery manufactured as described above is preferably initialized after the manufacturing or before the use. The initialization is not particularly limited, and it is possible to initialize the all-solid state secondary battery by, for example, carrying out initial charging and discharging in a state where the pressing pressure is increased and then decreasing the pressure up to a pressure at which the all-solid state secondary battery is ordinarily used.

[Use of all-Solid State Secondary Battery]

The all-solid state secondary battery according to the embodiment of the present invention can be applied to a variety of usages. Application aspects are not particularly limited, and in the case of being mounted in electronic devices, examples thereof include notebook computers, pen-based input personal computers, mobile personal computers, e-book players, mobile phones, cordless phone handsets, pagers, handy terminals, portable faxes, mobile copiers, portable printers, headphone stereos, video movies, liquid crystal televisions, handy cleaners, portable CDs, mini discs, electric shavers, transceivers, electronic notebooks, calculators, portable tape recorders, radios, backup power supplies, memory cards, and the like. Additionally, examples of consumer usages include automobiles (electric cars and the like), electric vehicles, motors, lighting equipment, toys, game devices, road conditioners, watches, strobes, cameras, medical devices (pacemakers, hearing aids, shoulder massage devices, and the like), and the like. Furthermore, the all-solid state laminated secondary battery can be used for a variety of military usages and universe usages. In addition, the all-solid state laminated secondary battery can also be combined with solar batteries.

The term “all-solid state secondary battery” refers to a secondary battery in which a positive electrode, a negative electrode, and a electrolyte are all solid. In other words, all-solid state secondary batteries are differentiated from electrolytic solution-type secondary batteries in which a carbonate-based solvent is used as an electrolyte. Among these, the present invention is assumed to be an inorganic all-solid state secondary battery. All-solid state secondary batteries are classified into organic (high-molecular-weight) all-solid state secondary batteries in which a high-molecular-weight compound such as polyethylene oxide is used as an electrolyte and inorganic all-solid state secondary batteries in which the above described Li—P—S-based glass, LLT, LLZ, or the like is used. The application of organic compounds to inorganic all-solid state secondary batteries is not inhibited, and the organic compounds as binders of positive electrode active materials, negative electrode active materials, and inorganic solid electrolyte or additives can be applied.

Inorganic solid electrolytes are differentiated from electrolytes in which the above described high-molecular-weight compound is used as an ion conductive medium (high-molecular-weight electrolyte), and inorganic compounds serve as ion conductive media. Specific examples thereof include the above described Li—P—S-based glass, LLT, and LLZ. Inorganic solid electrolytes itself do not release positive ions (Li ions) and exhibit an ion transportation function. In contrast, there are cases where materials serving as an ion supply source which is added to electrolytic solutions or solid electrolyte layers and releases positive ions (Li ions) are referred to as electrolytes. In a case of being differentiated from electrolytes as the ion transportation materials, the materials are referred to as “electrolyte salts” or “supporting electrolytes”. Examples the electrolyte salt include LiTFSI.

In the present invention, the term “composition” refers to a mixture obtained by uniformly mixing two or more components. Here, compositions may substantially maintain uniformity, and may partially include agglomeration or uneven distribution in a range of exhibiting desired effects.

### EXAMPLES

The present invention will be described in more detail based on Examples, but the present invention is not construed as being limited to these embodiments.

[Synthesis of Sulfide-Based Inorganic Solid Electrolyte Li—P—S-Based Glass]

As a sulfide-based inorganic solid electrolyte, Li—P—S-based glass was synthesized with reference to T. Ohtomo, A. Hayashi, M. Tatsumisago, Y. Tsuchida, S. Hama, K. Kawamoto, Journal of Power Sources, 233, (2013), pp. 231 to 235 and A. Hayashi, S. Hama, H. Morimoto, M. Tatsumisago, T. Minami, Chem. Lett., (2001), pp. 872 and 873 (all are non-patent documents).

In a glove box under an argon atmosphere (dew point: −70° C.), lithium sulfide (Li₂S, manufactured by Aldrich-Sigma, Co. LLC. Purity: >99.98%) (2.42 g) and diphosphoruspentasulfide (P₂S₅, manufactured by Aldrich-Sigma, Co. LLC. Purity: >99%) (3.90 g) were respectively weighed, injected into an agate mortar, and mixed using an agate muddler for five minutes. The mixing ratio between Li₂S and P₂S₅(Li₂S:P₂S₅) was set to 75:25 in terms of molar ratio.

66 g of zirconia beads having a diameter of 5 mm were injected into a 45 mL zirconia container (manufactured by Fritsch Japan Co., Ltd.), the full amount of the mixture was injected thereinto, and the container was sealed in an argon atmosphere. The container was set in a planetary ball mill P-7 (trade name, manufactured by Fritsch Japan Co., Ltd.), mechanical milling was carried out at a temperature of 25° C. and a rotation speed of 510 rpm for 20 hours, and 6.20 g of yellow powder of a sulfide-based inorganic solid electrolyte (in some cases, represented by Li—P—S-based glass or Li—P—S) was obtained.

<Production of Positive Electrode Sheet Under Condition 7>

A positive electrode sheet described in Table 1 below was produced. The positive electrode sheet has a configuration shown in FIG. 1.

—Preparation of Composition for Forming Conductor Layer—

5 g of carbon particles having an average particle diameter of 2.1 μm and 3 g of butadiene rubber (binder, product number: 182907, manufactured by Sigma-Aldrich Co. LLC) as a binder (D) were added to 100 g of xylene, and the mixture was dispersed for one hour at room temperature (25° C.) using a planetary mixer to obtain a composition for forming a conductor layer.

—Preparation of Positive Electrode Composition Slurry—

After 160 zirconia beads having a diameter of 5 mm were introduced to a zirconia 45 mL container (manufactured by Fritsch Japan Co., Ltd.), 2.0 g of Li—P—S, 0.1 g of PVdF-HFP (a copolymer of polyvinylene difluoride and hexafluoropropylene) (manufactured by Arkema S.A.) as a binder, and 5 g of heptane were added, and then the container was set to a planetary ball mill P-7 manufactured by Fritsch Japan Co., Ltd., and the wet dispersion was performed for 30 minutes at room temperature at the rotation speed of 350 rpm to obtain a slurry of the solid electrolyte composition. 9.0 g of lithium nickel manganese cobaltate, 0.2 g of acetylene black, and heptane were added as an active material (A) to the above described container, and the container was set to a planetary ball mill P-7 manufactured by Fritsch Japan Co., Ltd., and the wet dispersion was performed for 10 minutes at room temperature at the rotation speed of 150 rpm to obtain a positive electrode composition slurry.

—Formation of Conductor Layer 2—

A composition for forming a conductor layer was applied onto an aluminum foil (electrode collector 1) having a thickness of 20 μm by an applicator (trade name: SA-201 Baker type applicator, manufactured by Tester Sangyo Co., Ltd.) and blast dried at 100° C. for four hours to obtain an aluminum foil formed with a conductor layer 2. A thickness of the conductor layer 2 was 5 μm.

—Formation of Positive Electrode Active Material Layer 3b—

The positive electrode composition slurry was applied on the conductor layer 2 by an applicator (trade name: SA-201 Baker type applicator, manufactured by Tester Sangyo Co., Ltd.), and heated and dried at 100° C. for one hour to form a positive electrode active material layer 3b, and then a positive electrode sheet was obtained. A thickness of the positive electrode active material layer 3b was 80 μm.

<Production of Positive Electrode Sheet Under Conditions 1 to 6 and 8 to 24>

Positive electrode sheets under conditions 1 to 6 and 8 to 24 were produced in the same manner as in the positive electrode sheet under condition 7, except that carbon particles or aluminum particles having an average particle diameter shown in Table 1 below were used, Li—P—S of Rₛₑ and the active material (A) of Rₐₘ shown in Table 1 below were used, and whether or not the binder (D) was used and the thickness of the conductor layer, in the production of the positive electrode sheet under condition 7. A median diameter of Li—P—S was adjusted based on the time for performing wet dispersion at the rotation speed of 350 rpm in the preparation of the positive electrode composition slurry. Specifically, by performing wet dispersion at 350 rpm for five minutes, 30 minutes, 2 hours, 4 hours, 6 hours, and 8 hours, median diameters of 9.5 μm, 6.8 μm, 1 μm, 0.4 μm, 0.1 μm, and 0.05 μm were obtained as a median diameter of Li—P—S. The conductor layer was adjusted to a desired thickness by adjusting clearance of the applicator.

<Production of Negative Electrode Sheet Under Condition 25>

A negative electrode sheet described in Table 1 below was produced. The negative electrode sheet has a configuration shown in FIG. 1.

—Preparation of Composition for Forming Conductor Layer—

5 g of carbon particles having an average particle diameter of 4.0 μm and 3 g of butadiene rubber (binder, product number: 182907, manufactured by Sigma-Aldrich Co. LLC) as a binder (D) were added to 100 g of xylene, and the mixture was dispersed for one hour at room temperature (25° C.) using a planetary mixer to obtain a composition for forming a conductor layer.

—Preparation of Negative Electrode Composition Slurry—

After 160 zirconia beads having a diameter of 5 mm were introduced to a zirconia 45 mL container (manufactured by Fritsch Japan Co., Ltd.), 2.0 g of Li—P—S, 0.1 g of PVdF-HFP (a copolymer of polyvinylene difluoride and hexafluoropropylene) (manufactured by Arkema S.A.) as a binder (E), and 5 g of heptane were added, and then the container was set to a planetary ball mill P-7 manufactured by Fritsch Japan Co., Ltd., and the wet dispersion was performed for 30 minutes at room temperature at the rotation speed of 350 rpm to obtain a slurry of the solid electrolyte composition. 5.0 g of graphite: CGB20 (trade name, median diameter: 20 μm, manufactured by Nippon Graphite co., ltd.) was introduced into the container as a negative electrode active material, and the container was set to a planetary ball mill P-7 manufactured by Fritsch Japan Co., Ltd., and the wet dispersion was performed for 10 minutes at room temperature at the rotation speed of 150 rpm to obtain a negative electrode composition slurry.

—Formation of Conductor Layer 2—

A composition for forming a conductor layer was applied onto a SUS foil (electrode collector 1) having a thickness of 20 μm by an applicator (trade name: SA-201 Baker type applicator, manufactured by Tester Sangyo Co., Ltd.) and blast dried at 100° C. for four hours to obtain a SUS foil formed with a conductor layer 2. A thickness of the conductor layer 2 was 4.5 μm.

—Formation of Negative Electrode Active Material Layer 3a—

The negative electrode composition slurry was applied on the conductor layer 2 by an applicator (trade name: SA-201 Baker type applicator, manufactured by Tester Sangyo Co., Ltd.), and heated and dried at 100° C. for one hour to form a negative electrode active material layer 3a, and then a negative electrode sheet was obtained. A thickness of the negative electrode active material layer 3a was 80 μm.

<Production of Negative Electrode Sheet Under Conditions 26 to 28>

Negative electrode sheets under conditions 26 to 28 were produced in the same manner as in the negative electrode sheet under condition 25, except that carbon particles having an average particle diameter shown in Table 1 below was used and the active material (A) of Rₐₘ shown in Table I below was used, in the production of the negative electrode sheet under condition 25.

<Measurement Method of Average Particle Diameter (Volume Average Particle Diameter) of Carbon Particles (C1) and Aluminum Particles>

A dispersion liquid of 1% by mass of the carbon particles is prepared through dilution and adjustment by using heptane in a 20 mL sample bottle. The diluted dispersion specimen is irradiated with 1 kHz ultrasonic waves for 10 minutes and immediately used, and then data capturing is carried out 50 times using this dispersion liquid specimen, a laser diffraction/scattering-type particle size distribution measurement instrument LA-920 (manufactured by Horiba Ltd.), and a silica cell for measurement at a temperature of 25° C., thereby obtaining a volume-average particle diameter. Regarding other detailed conditions and the like, the description of JIS Z 8828:2013 “particle diameter analysis-Dynamic light scattering method” was referred to as necessary. Five specimens were produced and measured per level, and the average values thereof are employed.

Aluminum particles were measured in the same manner as carbon particles.

<Measurement Method of Layer Thickness>

The thickness of the conductor layer was determined as follows.

The manufactured positive electrode sheet was cross sectioned using an ion milling apparatus (trade name “IM4000PLUS”, Hitachi High-Technologies Corporation) under the condition of an acceleration voltage of 3 kV, and from an image imaged by a scanning electron microscope (SEM-EDX) at the magnification was 1000 times, thicknesses at 10 points of the conductor layer were measured to determine an average value thereof.

The thickness of the positive electrode active material layer is a value obtained by subtracting the thickness of the conductor layer from the total thickness of the positive electrode active material layer and the conductor layer.

<Measuring Method of Median Diameter>

A median diameter Rₐₘ of the active material (A) and a median diameter Rₛₑ of the inorganic solid electrolyte (B) in the positive electrode active material layer were measured as follows.

The manufactured positive electrode sheet was cross sectioned using the ion milling apparatus under the condition of an acceleration voltage of 3 kV, and an image imaged by a scanning electron microscope (SEM-EDX, manufactured by Hitachi High-Technologies Corporation, “TM3030” (trade name)) at the magnification was 2500 times was obtained.

EDX measurement was performed for the above view, and the active material and the inorganic solid electrolyte were specified. This image was analyzed using ImageJ, and a maximum value of distribution of a area-converted diameter determined from an area calculated from about 100 (90 to 110) particles was defined as a median diameter.

<Measuring method of maximum height roughness Rz>

(1) The maximum height roughness Rz of the conductor layer on a surface of the positive electrode active material layer side in the sheet after forming the conductor layer 2 was measured according to JIS B 0601:2013 using the following measuring device and under the following conditions.
(2) Furthermore, the all-solid state secondary battery described below was disassembled, the positive electrode active material layer was peeled off from the conductor layer 2, and the maximum height roughness Rz of the conductor layer on the surface of the positive electrode active material layer side was measured according to JIS B 0601:2013 using the following measuring device and under the following conditions.

The measured values of (1) and (2) were practically the same (the measured value of (2) was within a range of ±0.05 of the measured value described in (1)).

Rz described in Table 1 below is the measured value of the above (1).

Measuring apparatus: three-dimensional microprofile measuring device (model: ET-4000A), manufactured by Kosaka Laboratory Ltd.

Analyzer: three-dimensional surface roughness analysis system (model: TDA-31)

Stylus: tip radius=0.5 μmR, diameter=2 μm, made of diamond

Stylus pressure: 1 μN

Measurement length: 5.0 mm

Measurement rate: 0.02 mm/s

Measurement interval: 0.62 μm

Cutoff: None

Filtering mode: Gaussian space-type

Leveling: performed (quadratic curve)

<Binding Properties Test>

The binding properties of the positive electrode sheet for an all-solid state secondary battery was evaluated.

Each positive electrode sheet for an all-solid state secondary battery was wound around rods having different diameters from each other, and presence or absence of peeling of the positive electrode active material layer from the conductor layer was confirmed. The binding properties were evaluated depending on which of the following evaluation ranks included minimum diameter of the rod in which the all-solid state secondary battery was wound without causing peeling. It was also confirmed that there was no peeling between the positive electrode active material layer and the conductor layer even after the all-solid state secondary battery was wound with the above described rod having the minimum diameter and after the all-solid state secondary battery was released.

The test represents that the smaller the minimum diameter of the rod, the more firm the binding properties, and an acceptance level is evaluation rank “D” or higher.

—Evaluation Rank of Binding Properties—

A: Minimum diameter<2 mm

B: 2 mm≤minimum diameter<4 mm

C: 4 mm≤minimum diameter<6 mm

D: 6 mm≤minimum diameter<10 mm

E: 10 mm≤minimum diameter<14 mm

F: 14 mm≤minimum diameter<20 mm

G: 20 mm≤

<Battery Characteristics Test>

An all-solid state secondary battery was produced using the positive electrode sheet manufactured as described above.

The positive electrode sheet was punched in a disk-shape having a diameter of 10 mmφ and placed in a polyethylene terephthalate (PET) cylinder having an inner diameter of 10 mmφ. 30 mg of Li—P—S powder was put on the positive electrode active material layer side in the cylinder, and a stainless steel (SUS) rod of 10 mmφ was inserted through both sides of the cylinder. The electrode collector side of the positive electrode sheet and Li—P—S were pressed with the SUS rod by applying a pressure of 350 MPa. Once the SUS rod on the Li—P—S side was removed, a 9 mmφ disc-shaped indium (In) sheet (thickness: 20 μm) and a 9 mmφ of Li sheet (thickness: 20 μm) were placed on the Li—P—S inside the cylinder. The removed SUS rod was reinserted into the cylinder, and fixed under a pressure of 50 MPa. Thus, an all-solid state secondary battery having a configuration of an aluminum foil (thickness: 20 μm), a positive electrode active material layer (thickness: 80 μm), a sulfide-based inorganic solid electrolyte layer (thickness: 200 μm), and a negative electrode active material layer (In/Li sheet, thickness: 30 μm) was obtained.

An all-solid state secondary battery was produced using the negative electrode sheet manufactured as described above.

The negative electrode sheet was punched in a disk-shape having a diameter of 10 mmφ and placed in a polyethylene terephthalate (PET) cylinder having an inner diameter of 10 mmφ. 30 mg of Li—P—S powder was put on the negative electrode active material layer side in the cylinder, and a SUS rod of 10 mmφ was inserted through both sides of the cylinder. The electrode collector side of the negative electrode sheet and Li—P—S were pressed with the SUS rod by applying a pressure of 350 MPa. Once the SUS rod on the Li—P—S side was removed, a 9 mmφ disc-shaped indium (In) sheet (thickness: 20 μm) and a 9 mmφ of Li sheet (thickness: 20 μm) were placed on the Li—P—S inside the cylinder. The removed SUS rod was reinserted into the cylinder, and fixed under a pressure of 50 MPa. Thus, an all-solid state secondary battery having a configuration of an aluminum foil (thickness: 20 μm), a negative electrode active material layer (thickness: 80 μm), a sulfide-based inorganic solid electrolyte layer (thickness: 200 μm), and a positive electrode active material layer (In/Li sheet, thickness: 30 μm) was obtained.

Charging and discharging characteristics of the produced all-solid state secondary battery was measured by a charging and discharging evaluation device manufactured by Toyo System Co., Ltd. (TOSCAT-3000). Charging was performed at a current density of 0.5 mA/cm² until a charging voltage reached 3.6 V, and after reaching 3.6 V, charging was performed at a constant voltage until the current density became less than 0.05 mA/cm². Discharging was performed at a current density of 0.5 mA/cm² until the voltage reached 1.9 V, which is repeated, and therefore the result discharge capacity is compared with a discharge capacity at the third cycle.

The followings are set to evaluation ranks as relative values in a case where the discharge capacity of condition 2 is 1 (dimensionless as Ah is normalized). An acceptance level of the present test is Evaluation rank “E” or higher.

—EVALUATION Rank of Battery Characteristics Test—
A: 2.0<relative value of discharge capacity
B: 1.8<relative value of discharge capacity≤2.0
C: 1.6<relative value of discharge capacity≤1.8
D: 1.4<relative value of discharge capacity≤1.6
E: 1.2<relative value of discharge capacity≤1.4
F: 1<relative value of discharge capacity≤1.2
G: relative value of discharge capacity≤1

TABLE 1
(Positive electrode sheet and battery)

| | | | | | Conductor layer | | |
|---|---|---|---|---|---|---|---|
| | | | | | | Average | |
| | | | | | | particle | |
| | | Binding | | | | diameter | Binder |
| Condition | Note | properties | Battery performance | Support | Particles | (μm) | (D) |
| 1 | Comparative | G | Battery production is | Al | Carbon | 1.2 | Butadiene rubber |
| | Example | | impossible | | | | |
| 2 | Example | D | E | Al | Carbon | 2.1 | Butadiene rubber |
| 3 | Example | C | D | Al | Carbon | 4.0 | Butadiene rubber |
| 4 | Comparative | G | Battery production is | Al | Carbon | 2.1 | Butadicne rubber |
| | Example | | impossible | | | | |
| 5 | Comparative | G | Battery production is | Al | Carbon | 2.1 | Butadiene rubber |
| | Example | | impossible | | | | |
| 6 | Comparative | G | Battery production is | Al | Carbon | 1.2 | Butadiene rubber |
| | Example | | impossible | | | | |
| 7 | Example | C | D | Al | Carbon | 2.1 | Butadiene rubber |
| 8 | Example | A | C | Al | Carbon | 4.0 | Butadiene rubber |
| 9 | Comparative | G | Battery production is | Al | Carbon | 1.2 | Butadiene rubber |
| | Example | | impossible | | | | |
| 10 | Example | A | C | Al | Carbon | 2.1 | Butadiene rubber |
| 11 | Example | A | B | Al | Carbon | 4.0 | Butadiene rubber |
| 12 | Example | B | C | Al | Carbon | 4.0 | Butadiene rubber |
| 13 | Example | B | E | Al | Carbon | 4.0 | Butadiene rubber |
| 14 | Comparative | B | G | Al | Carbon | 4.0 | Butadiene rubber |
| | Example | | | | | | |
| 15 | Example | C | B | Al | Carbon | 4.0 | None |
| 16 | Example | A | B | Al | Aluminum | 4.5 | Butadiene rubber |
| 17 | Example | A | A | Al | Carbon | 4.0 | Butadiene rubber |
| 18 | Example | A | A | Al | Carbon | 4.0 | Butadiene rubber |
| 19 | Example | B | B | Al | Carbon | 4.0 | Butadiene rubber |
| 20 | Example | C | C | Al | Carbon | 4.0 | Butadiene rubber |
| 21 | Example | A | AA | Al | Carbon | 1.2 | Butadiene rubber |
| 22 | Example | A | AA | Al | Carbon | 1.2 | Butadiene rubber |
| 23 | Example | D | AA | Al | Carbon | 1.2 | Butadiene rubber |
| 24 | Comparative | G | Battery production is | Al | None | None | None |
| | Example | | impossible | | | | |

| | | | Active | | | | | |
|---|---|---|---|---|---|---|---|---|
| | Conductor layer | | material layer | | | | | |
| | Thickness¹⁾ | Rz | Thickness²⁾ | Rse | Ram | Ram/ | Rz/ | Rz/ |
| Condition | (μm) | (μm) | (μm) | (μm) | (μm) | Rse | Rse | Ram |
| 1 | 5.0 | 1.72 | 80 | 9.5 | 9.2 | 0.97 | 0.18 | 0.19 |
| 2 | 5.0 | 3.50 | 80 | 9.5 | 9.2 | 0.97 | 0.37 | 0.38 |
| 3 | 5.0 | 4.64 | 80 | 9.5 | 9.2 | 0.97 | 0.49 | 0.50 |
| 4 | 5,0 | 3.50 | 80 | 9.5 | 36 | 3.79 | 0.37 | 0.10 |
| 5 | 5.0 | 3.50 | 80 | 9.5 | 65 | 6.84 | 0.37 | 0.05 |
| 6 | 5.0 | 1.72 | 80 | 6.8 | 9.2 | 1.35 | 0.25 | 0.19 |
| 7 | 5.0 | 3.50 | 80 | 6.8 | 9.2 | 1.35 | 0.51 | 0.38 |
| 8 | 5,0 | 4.64 | 80 | 6.8 | 9.2 | 1.35 | 0.68 | 0.50 |
| 9 | 5.0 | 1.72 | 80 | 1.0 | 9.2 | 9.20 | 1.72 | 0.19 |
| 10 | 5.0 | 3.50 | 80 | 1.0 | 9.2 | 9.20 | 3.50 | 0.38 |
| 11 | 5.0 | 4.64 | 80 | 1.0 | 9.2 | 9.20 | 4.64 | 0.50 |
| 12 | 5.0 | 4.64 | 80 | 0.4 | 9.2 | 23.00 | 11.60 | 0.50 |
| 13 | 5.0 | 4.64 | 80 | 0.06 | 9.2 | 153.33 | 77.33 | 0.50 |
| 14 | 5.0 | 4.64 | 80 | 0.05 | 9.2 | 184.00 | 92.80 | 0.50 |
| 15 | 5.0 | 4.9 | 80 | 1.0 | 9.2 | 9.20 | 4.90 | 0.53 |
| 16 | 5.0 | 4.8 | 80 | 6.8 | 9.2 | 1.35 | 0.71 | 0.52 |
| 17 | 5.0 | 4.64 | 80 | 0.4 | 3 | 7.50 | 11.60 | 1.55 |
| 18 | 5.0 | 4.64 | 80 | 0.4 | 1.1 | 2.75 | 11.60 | 4.22 |
| 19 | 5.0 | 4.64 | 80 | 0.4 | 0.5 | 1.25 | 11.60 | 9.28 |
| 20 | 5.0 | 4.64 | 80 | 0.4 | 0.2 | 0.50 | 11.60 | 23.20 |
| 21 | 2.0 | 3.10 | 80 | 1.0 | 3.0 | 3.00 | 3.10 | 1.03 |
| 22 | 1.0 | 3.05 | 80 | 1.0 | 3.0 | 3.00 | 3.05 | 1.02 |
| 23 | 0.5 | 3.02 | 80 | 1.0 | 3.0 | 3.00 | 3.02 | 1.01 |
| 24 | 0.0 | 2.00 | 80 | 1.0 | 3.0 | 3.00 | 2.00 | 0.67 |

TABLE 2
(Negative electrode sheet and battery)

| | | | | | Conductor layer | | | | | Active | | | | | |
|---|---|---|---|---|---|---|---|---|---|---|---|---|---|---|---|
| | | | | | | Average | | | | material layer | | | | | |
| | | | | | | particle | | Thick- | | Thick- | | | | | |
| Con- | | Binding | Battery | | | diameter | Binder | ness¹⁾ | Rz | ness²⁾ | Rse | Ram | Ram/ | Rz/ | Rz/ |
| dition | Note | properties | performance | Support | Particles | (μm) | (D) | (μm) | (μm) | (μm) | (μm) | (μm) | Rae | Rse | Ram |
| 25 | Example | A | B | SUS | Carbon | 4.0 | Butadiene | 4.5 | 4.7 | 120 | 1.0 | 10 | 10.00 | 4.70 | 0.47 |
| | | | | | | | rubber | | | | | | | | |
| 26 | Example | A | A | SUS | Carbon | 4.0 | Butadiene | 4.5 | 4.7 | 120 | 1.0 | 3 | 3.00 | 4.70 | 1.57 |
| | | | | | | | rubber | | | | | | | | |
| 27 | Example | C | C | SUS | Carbon | 4.0 | Butadiene | 4.5 | 4.7 | 120 | 1.0 | 0.4 | 0.40 | 4.70 | 11.75 |
| | | | | | | | rubber | | | | | | | | |
| 28 | Compar- | G | Battery | SUS | Carbon | 1.2 | Butadiene | 4.5 | 2.5 | 120 | 1.0 | 0.4 | 0.40 | 2.50 | 6.25 |
| | ative | | production | | | | rubber | | | | | | | | |
| | Example | | is | | | | | | | | | | | | |
| | | | impossible | | | | | | | | | | | | |

<Notes in Table>

Thickness ¹): Thickness of conductor layer

Thickness ²): Thickness of active material layer

### Conditions 1, 4 to 6, 9 and 24 (Comparative Example)

Under conditions 1, 4 to 6, 9, and 24, an all-solid state secondary battery could not be produced since peeling from the electrode collector or crack is generated on the conductor layer in a case where the positive electrode sheet was punched into a disk having a diameter of 10 mmφ.

### Positive Electrode Sheet and all-Solid State Secondary Battery Under Condition 14 (Comparative Example)

The positive electrode sheet and the all-solid state secondary battery under condition 14 do not satisfy Expression (2) defined in the present invention. In the positive electrode sheet under condition 14, the binding properties were at an acceptable level. However, the battery performance of the all-solid state secondary battery under condition 14 was insufficient.

### Positive Electrode Sheet and all-Solid State Secondary Battery Under Conditions 2, 3, 7, 8, 10 to 13, and 15 to 23 (Example)

In all of the positive electrode sheets under conditions 2, 3, 7, 8, 10 to 13 and 15 to 23, the binding properties were at an acceptable level, and the battery performance of the all-solid state secondary battery under conditions 2, 3, 7, 8, 10 to 13 and 15 to 23 was also at an acceptable level. Furthermore, it is found that the conductor layer has a thickness in a specific range, whereby the positive electrode sheets under conditions 21 to 23 have more excellent battery performance.

### Condition 28 (Comparative Example)

Under condition 28, an all-solid state secondary battery could not be produced since peeling from the electrode collector is generated on the conductor layer in a case where the negative electrode sheet was punched into a disk having a diameter of 10 mmφ.

### Negative Electrode Sheet and all-Solid State Secondary Battery Under Conditions 25 to 27 (Example)

In all of the negative electrode sheets under conditions 25 to 27, the binding properties were at an acceptable level, and the battery performance of the all-solid state secondary battery under conditions 25 to 27 was also at an acceptable level.

The present invention has been described together with the embodiment; however, unless particularly specified, the present inventors do not intend to limit the present invention to any detailed portion of the description and consider that the present invention is supposed to be broadly interpreted within the concept and scope of the present invention described in the claims.

### EXPLANATION OF REFERENCES

1 electrode current collector (positive electrode collector or negative electrode collector)
1a negative electrode collector
1b positive electrode collector
2 conductor layer
2a conductor layer
2b conductor layer
3 electrode active material layer (positive electrode active material layer or negative electrode active material layer)
3a negative electrode active material layer
3b positive electrode active material layer
4 solid electrolyte layer
5 operation portion
10 electrode sheet for all-solid state secondary battery
100 all-solid state secondary battery

What is claimed is:

1. An electrode sheet for an all-solid state secondary battery, comprising, in the following order:
a conductor layer containing conductive particles (C); and an electrode active material layer on at least one surface of an electrode collector,
wherein the electrode active material layer containing an active material (A) having a median diameter Rₐₘ and an inorganic solid electrolyte (B) having a median diameter Rₛₑ is provided on a surface of the conductor layer having a maximum height roughness Rz of 3.0 to 10 μm, which is defined in JIS B 0601:2013, and
Rₐₘ, Rₛₑ, and Rz satisfy the following Expressions (1), (2) and (3a).
0.15<Rz/Rₐₘ<90 Expression (1):
0.15<Rz/Rₛₑ<90 Expression (2):
1<Rₐₘ/Rₛₑ<100 Expression (3a):

2. The electrode sheet for an all-solid state secondary battery according to claim 1, wherein the conductive particles (C) include carbon particles (C1).

3. The electrode sheet for an all-solid state secondary battery according to claim 1, wherein Rₛₑ is 0.2 μm or more and 7 μm or less.

4. The electrode sheet for an all-solid state secondary battery according to claim 1, wherein Rₐₘ is 0.5 μm or more and 10 μm or less.

5. The electrode sheet for an all-solid state secondary battery according to claim 1, wherein the conductor layer contains a binder (D).

6. The electrode sheet for an all-solid state secondary battery according to claim 5, wherein the binder (D) is at least one of rubber, a thermoplastic elastomer, a hydrocarbon resin, a silicone resin, an acrylic resin, or fluoro rubber.

7. The electrode sheet for an all-solid state secondary battery according to claim 1, wherein the Expression (1) represents 0.4<Rz/Rₐₘ<90.

8. The electrode sheet for an all-solid state secondary battery according to claim 1, wherein the Expression (2) represents 0.6<Rz/Rₛₑ<90.

9. The electrode sheet for an all-solid state secondary battery according to claim 1, wherein the Expression (3a) represents 1<Rₐₘ/R_{sc}<20.

10. The electrode sheet for an all-solid state secondary battery according to claim 1, wherein the inorganic solid electrolyte (B) is a sulfide-based inorganic solid electrolyte.

11. The electrode sheet for an all-solid state secondary battery according to claim 1, wherein the conductive particles (C) comprise conductive inorganic particles or carbon particles (C1).

12. The electrode sheet for an all-solid state secondary battery according to claim 11, wherein the conductive inorganic particles are at least one of aluminum particles, silver particles, copper particles, indium oxide particles, tin particles, tin oxide particles, or titanium oxide particles.

13. An all-solid state secondary battery comprising the electrode sheet for an all-solid state secondary battery according to claim 1.

14. A method of manufacturing an electrode sheet for an all-solid state secondary battery, which includes, in the following order: a conductor layer containing conductive particles (C);
and an electrode active material layer on at least one surface of an electrode collector, and in which the electrode active material layer containing an active material (A) having a median diameter Rₐₘ and an inorganic solid electrolyte (B) having a median diameter Rₛₑ is provided on a surface of the conductor layer having a maximum height roughness Rz of 3.0 to 10 μm, which is defined in JIS B 0601:2013, the method comprising:
a step of adjusting Rz with the conductive particles (C),
wherein Rₐₘ, Rₛₑ, and Rz satisfy the following Expressions (1), (2) and (3a).
0.15<Rz/Rₐₘ<90 Expression (1):
0.15<Rz/Rₛₑ<90 Expression (2):
1<Rₐₘ/Rₛₑ<100 Expression (3a):

15. The method of manufacturing an electrode sheet for an all-solid state secondary battery according to claim 14, wherein the conductive particles (C) include carbon particles (C1).

16. The method of manufacturing an electrode sheet for an all-solid state secondary battery according to claim 14, wherein Rₛₑ is 0.2 μm or more and 7 μm or less.

17. The method of manufacturing an electrode sheet for an all-solid state secondary battery according to claim 14, wherein Rₐₘ is 0.5 μm or more and 10 μm or less.

18. The method of manufacturing an electrode sheet for an all-solid state secondary battery according to claim 14, wherein the conductor layer contains a binder (D).

19. The method of manufacturing an electrode sheet for an all-solid state secondary battery according to claim 18, wherein the binder (D) is at least one of rubber, a thermoplastic elastomer, a hydrocarbon resin, a silicone resin, an acrylic resin, or fluoro rubber.

20. The method of manufacturing an electrode sheet for an all-solid state secondary battery according to claim 14, wherein the Expression (1) represents 0.4<Rz/Rₐₘ<90.

21. The method of manufacturing an electrode sheet for an all-solid state secondary battery according to claim 14, wherein the Expression (2) represents 0.6<Rz/Rₛₑ<90.

22. The method of manufacturing an electrode sheet for an all-solid state secondary battery according to claim 14, wherein the Expression (3a) represents 1<Rₐₘ/Rₛₑ<20.

23. The method of manufacturing an electrode sheet for an all-solid state secondary battery according to claim 14, wherein the inorganic solid electrolyte (B) is a sulfide-based inorganic solid electrolyte.

24. The method of manufacturing an electrode sheet for an all-solid state secondary battery according to claim 14, wherein the conductive particles (C) comprise conductive inorganic particles or carbon particles (C1).

25. The method of manufacturing an electrode sheet for an all-solid state secondary battery according to claim 24, wherein the conductive inorganic particles are at least one of aluminum particles, silver particles, copper particles, indium oxide particles, tin particles, tin oxide particles, or titanium oxide particles.

26. A method of manufacturing an all-solid state secondary battery, comprising: a step of incorporating the electrode sheet for an all-solid state secondary battery, which is obtained by the method of manufacturing an electrode sheet for an all-solid state secondary battery according to claim 14.
